(19) United States
(12) Patent Application Publication
(10) Pub. No.: US 2004/0254837 A1
(43) Pub. Date: Dec. 16, 2004

(54) Consumer marketing research method and system

(76) Inventor: Kenneth S. Roshkoff, Villanova, PA (US)

Correspondence Address: DRINKER BIDDLE & REATH, ONE LOGAN SQUARE, 18TH AND CHERRY STREETS, PHILADELPHIA, PA, 19103-6996, US

(21) Appl. No.: 10/803,431

(22) Filed: Mar. 18, 2004

Related U.S. Application Data
(60) Provisional application No. 60/478,202, filed on Jun. 11, 2003.

(51) Int. Cl. G06F 17/60

(52) U.S. Cl. 705/14; 705/10; 705/41

(57) ABSTRACT

A consumer marketing research method and system including the steps of making available to at least one consumer a card comprising a microchip for storing information; activating the card via a triggering event; creating a consumer profile corresponding to the card in a central computer; enabling the at least one consumer to use the activated card when purchasing items; providing a card processor for performing at least one of accessing any information stored on the microchip, identifying any items purchased by the consumer, and recording information about the consumer's purchases; transferring information processed by the card processor to the profile; and, performing consumer marketing research using the consumer profile.

### FIELD OF THE INVENTION

The present invention relates to the field of consumer marketing research, particularly, to a method and system for conducting attitudinal and behavioral research.

### BACKGROUND

Consumer marketing research includes both attitudinal and behavioral market research. Consumer marketing research generally refers to the study of consumers and their purchasing habits and activities.

“Attitudinal research” generally describes that study which focuses on understanding consumers and how consumers make purchasing decisions. Attitudinal research can be defined as research that represents a person's ideas, convictions or liking with respect to a specific object or idea. Opinions are essentially expressions of attitudes. Consequently, attitudes and opinions can be used almost interchangeably to represent a person's ideas, convictions or liking with respect to a specific object or idea. Collecting consumer purchasing information allows, for example, product manufacturers, to drill down to human purchasing dispositions. Attitudinal research may assist in determining the likelihood of product purchase, how future products can be improved, whether product changes are acceptable, etc.

“Behavioral research” can be defined as the study of consumer behavior. Behavioral research studies what people do, that is, how people act. Behavioral research concerns what people have done or are doing.

Behavioral data reflecting what consumers actually purchase in the marketplace, as opposed to what researchers infer consumers will or will not purchase, has always been available. However, such behavioral data has been difficult to capture for a variety of reasons.

The field of consumer marketing research, which includes attitudinal and behavioral market research, requires gathering data related to, for example, consumer attitudes and consumer behavior, in order to analyze such attitudes and behavior. Consumer data may be gathered through the distribution of incentive items activated via participation in consumer research programs and consumer surveys, such as described in U.S. Patent Publication 20030070338, and U.S. Pat. Nos. 5,489,123, 5,308,119, and 6,042,149, by the present inventor.

Although the distribution of incentive items activated by participation in consumer surveys is a useful and acceptable way of collecting data for attitudinal and behavioral research and providing consumers with a tangible incentive, there still exists the need for a more complete and accurate system that comprises an attitudinal research system, an incentive item delivery system, and means for keeping track of consumer purchasing habits, preferences and behavior.

Known methods of gathering information suffer various shortcomings. Typically, useful sales data (i.e., AC Nielsen's trial and repeat data reported from their Homescan Consumer Panel of approximately 61,500 U.S. households) are not available for review until well into a product's launch. Often, product manufacturers need to wait 8 to 10 months before a significant amount of trial and repeat information is gathered from actual purchasers of the new product in-market. The reason it takes so long to capture the trial and repeat information using known methods is due to the fact that the responsive panel is limited to only approximately 61,500 households who have agreed to participate in AC Nielsen's Homescan Consumer Panel and engage in the cumbersome process of manually scanning each product that is purchased by the household members.

When that data that is gathered is eventually made available, manufacturers are able to measure behavioral data (e.g., what consumers are buying, how many units of the product are purchased, etc.) but would not have an understanding as to why consumers behave in such a way. If there is a problem with the product, and the manufacturer waits for sales data (trial and repeat data), it could be many months before the existence of a problem is identified, and even longer until the reasons are identified. By then, stores carrying the products at issue may already be forcing the manufacturers to take their product off of their store shelves.

Not only is it essential to understand the reasons for consumer behavior shortly after the time of purchase, but it is also important to identify how customers feel once some time has elapsed and subsequent category purchases have been made. Manufacturers may wish to develop a customer panel for use in future research projects, whether qualitative or quantitative.

Radio Frequency Identification (RFID) technology is becoming an important identification technology for tracking objects such as luggage, packages, merchandise, and the like. RFID systems provide identification functions not found in more conventional identification technologies such as optical indicia (e.g., bar code) recognition systems. For example, an RFID system may utilize RFID tags containing read/write memory of several Mb. Further, several such RFID tags may be read by a system at one time. These RFID tags are readable at a distance and do not require direct line-of-sight view by the reading apparatus. Such RFID tags may be incorporated into, for example, cards such as credit or debit cards that consumers can carry easily in their wallets, purses, or pockets. RFID systems and tags are described in detail in U.S. Pat. No. 6,100,804.

A typical RFID tag or transponder consists of a semiconductor chip having RF circuits, logic, circuits, memory, and an antenna (and a battery in the case of active tags), mounted on a substrate. This substrate may be enclosed (encapsulated, laminated, etc.) to protect it from the environment. Known to the art are thin RFID tags such as the thin RFID tag disclosed in U.S. Pat. No. 5,528,222.

The terms “chips,” “computer chips,” and/or “microchips” as used herein encompass such RFID tags or microchips known in the art or described above and herein, as well as all other computer chips capable of performing the actions or tasks described herein. The microchips store and track information for various applications.

Product manufacturers and retail outlets are beginning to use RFID tags to track their products. Some attempts have been made to develop systems using RFID tags for tracking consumer purchasing behavior, and providing consumers with incentives such as discounts or program loyalty “points”. See, for example, U.S. Patent Publication No. 20030033211 A1 and U.S. Pat. Nos. 6,298,330, 6,450,407, 6,513,015, and 6,129,274.

Yet other systems have been devised to distribute coupons or loyalty points electronically or using computer systems to consumers. Such systems include: U.S. Patent Publication No. 20030033211 and U.S. Pat. Nos. 6,067,526, 6,012,038, 5,806,044, 6,584,448, and 5,907,850. These systems are directed to, inter alia, digital or electronic coupons, or cards that merely take the place of coupons. Another known system, shown in U.S. Pat. No. 6,334,110, is for analyzing consumer behavior and target marketing based on the time when such behavior occurs.

Prior art applications, such as U.S. Patent Publication No. 20030033211, disclose programs designed mainly as purchaser incentive and marketing promotions systems. Where known consumer incentive systems discuss consumer surveys, the purpose of such surveys is to create data to target consumers with promotional offers. However, such systems do not provide a level of consumer marketing research necessary to truly appreciate consumer choices, attitudes, or behavior.

The above-cited systems do not provide an integrated system for delivering a card or product package containing a microchip to a consumer, performing a consumer survey in order to activate the card, using the card to target specific incentives, and using a card kiosk to access information using the card. In addition, the above-cited systems do not provide a means for printing convenient shopping lists for consumers. The above-cited systems further do not provide for an integrated system comprising comprehensive market research and product purchase tracking. Most significantly, known systems do not provide a means for meaningful consumer marketing research utilizing available technology for tracking actual consumer behavior as it occurs in the marketplace.

### SUMMARY OF THE INVENTION

The system of the present invention generally comprises an consumer marketing research system utilizing available technology for collecting, tracking, monitoring, and analyzing consumer purchasing data. The system of the present invention further provides a means for utilizing consumer data collected in consumer marketing research programs to provide effective marketing for clients.

As used herein, the term “client” or “clients” may refer to the party ultimately using or benefiting from the information gathered by the system of the present invention. Thus, “clients” may refer to marketing or research firms, product manufacturers, retail stores, or any other party that could benefit from the information gathered by the system of the present invention. The system enables clients to conduct comprehensive consumer marketing research programs among actual purchasers of specific products that the clients are interested in monitoring.

The term “central computer” as used herein refers to a central processing unit or CPU, capable of running computer software applications, and having a memory capacity capable of storing data files, such as databases.

With the system of the present invention, consumer marketing feedback, including, but not limited to, attitudinal and behavioral feedback, from actual product purchasers and/or users may be supplied within the first quarter of a product launch. This allows manufacturers to take a more proactive, rather than reactive, response to consumer feedback (attitudinal and behavioral feedback).

The present invention comprises a system that uses cards comprising microchips and RFID technology for incentive programs, marketing research (both behavioral and attitudinal research), and coupon and loyalty programs. The present invention also encompasses a system for targeting consumers with specific incentive items or information based upon measured purchasing habits. The system of the present invention is designed to reward consumers for initial and/or continued participation in consumer marketing research programs. These rewards can be delivered via the system of the present invention in the form of (by way of example only): cash, coupons, free products or services, product samples, custom tailored shopping lists, etc.

The system of the present invention is not limited by the shortcomings of known marketing research systems. The system of the present invention is designed with a central objective focused on effectively conducting consumer marketing research for clients. The main objective of providing incentive offers in the context of the system of the present invention is to entice consumers to utilize the cards of the present invention for all transactions so that purchase patterns for various items can be studied for research purposes. The system is further designed to target and recruit the appropriate consumers for participation in detailed follow-up consumer surveys. The focus of attitudinal follow-up research is to capture a person's ideas, convictions or liking with respect to a specific object or idea, after having been provided sufficient time to fully experience the object or idea as they normally would in a natural setting. For example, if research is being conducted among purchasers of a new skin cream, we might want to capture factual information in the first phase of the research study. This information may include, names, addresses, phone numbers, emails, type of store where purchased, whether they have purchased this product previously, demographic information, etc. The follow-up research phase may be conducted at a preselected time, such as after extended use of the product. It is desirable to speak with users to capture their attitudes toward the product after they have had the opportunity to determine how well the product is working for them.

The results of these surveys will be utilized by clients in order to maintain a competitive advantage and stay apprised of what competitors are doing in the marketplace, and to produce and effectively market the client's own products with the best chance of success in the marketplace. Thus, the focus of the system of the present invention is not merely on repeat sales, but also on providing a product manufacturer with information that will provide the manufacturer an opportunity to have their products meet the measured demands of the marketplace.

The term “card,” as used herein, refers to any means by which microchips are delivered to a consumer for use with the present invention. Thus, traditional plastic credit or debit cards or similar flexible plastic cards are within the definition of “card” as used herein. The term “cards” also encompasses items having various shapes, materials, and sizes, so long as the item can carry the microchip. Examples of non-traditional cards include, but are not limited to plastic objects of varying shapes that can be secured on a key chain; keychains equipped with microchips; cell phones or cell phone holders; and personal digital assistants. With nanotechnology, it is possible to have a “card” as small as a grain of sand. Such “nano”-cards may be embedded, for example, inside a consumer's wallet or other object that the consumer carries. So long as an object can be equipped with a microchip of any type, it can be used as a “card” as that term is used herein.

In one aspect, the present invention comprises a card equipped with a microchip and capable of transmitting and/or receiving an RFID signal, whereby the card can transmit and store any information necessary for targeting consumers for consumer marketing research, tracking purchases, providing incentives, providing coupons, or other specifically designed behavioral and attitudinal research. The cards can store, by way of example and not by way of limitation, demographic information, information regarding products purchased by a consumer, special promotions to be received by a consumer, and product brand preferences.

In another aspect, the present invention is directed to a system whereby consumer purchasing habits are tracked and stored in a central computer by compiling information when a consumer uses a card for purchasing goods or services. A profile is created that is useful to both the consumer and businesses seeking to advertise to consumers.

In yet another aspect of the present invention, a card kiosk is provided for use by consumers with cards. By using the kiosk, consumers can obtain coupons, track purchases, or add value to the cards for purchasing goods or services.

Incentives may be provided to a consumer using a card based upon information gathered by the system in the consumer's profile. Incentives may include, for example, coupons, free products, funds provided in a consumer's profile, etc. Incentives may be accessed by, for example, processing a card with a card kiosk, using the card when purchasing items in a retail store, processing a card with a card processor, or using an internet website in communication with the central computer and profile. The present invention provides a number of benefits, including providing a system that is superior to offering incentives when a consumer leaves a retail store, because the system of the present invention puts incentives directly in consumers hands when they are shopping. The system of the present invention also provides incentives in advance for products a consumer has already purchased previously and tends to use frequently. The system may even determine specifically what is on a consumer's shopping list by enabling a consumer to register shopping lists on-line. The incentives, such as coupons, generated by the card kiosk could be used at any retail outlet with the appropriate RFID readers/transmitters, card kiosks, and card processing/reading equipment at checkout.

The system is also capable of tracking household purchase patterns with a direct link to consumers who purchase certain products, with the ability to contact such consumers for consumer marketing research.

By use of the system of the present invention, it can be determined precisely which products are purchased, enabling precisely targeted advertising and consumer research.

By use of the system of the present invention, the consumer is not locked into signing up with any particular service. Rather, the card may be used by any establishment equipped with card readers, processors and/or transmitters necessary to accomplish the goals of the present invention. It is the consumer's choice whether to share personal information, such as by participating in a consumer survey or market research program. In addition, card kiosks may be located at convenient locations separate from a retail store, freeing the consumer from shopping only at selected establishments.

### DESCRIPTION OF THE DRAWINGS

FIG. 1 shows an example of a card of the present invention.

FIG. 1a shows a consumer obtaining a card of the present invention by purchasing a product having a card affixed thereto.

FIG. 2 shows a consumer obtaining a card of the present invention by receiving a product sample.

FIG. 3 is a schematic representation of how a consumer obtaining a sample package with a card can activate such card and use it in the system of the present invention.

FIG. 4 is a schematic representation of card activation.

FIG. 5 shows the interaction of a card, retail checkout, card processor, central computer, central memory, and database of the present invention.

FIG. 6 shows the interaction of a card, a card kiosk, card processor, central computer, central memory, database, and profile of the present invention.

FIG. 7 shows a flow chart representation of the process of a consumer using a card at a retail checkout.

FIG. 8 shows a flow chart representation of the process of cross-marketing incentives based one consumer purchases according to the present invention.

FIG. 9 shows card readers communicating with other components of the present invention.

FIG. 10 advertisements being delivered to a consumer using the system of the present invention via hyper-sonic sound.

FIG. 11 shows a shopping cart processor of the present invention.

FIG. 12 shows a schematic representation of the use of an internet website for purposes of the present invention.

FIG. 13 shows card readers communicating with other components of the present invention.

FIG. 14 shows a portable product identification system according to the present invention.

FIG. 15 shows a consumer home equipped with a market research processor of the present invention.

FIG. 16 shows a vending machine for use with the system of the present invention.

FIG. 17 shows a schematic representation of consumer marketing research programs using data gathered by the system of the present invention.

FIG. 18 shows a schematic representation of how clients can put the results of consumer marketing research facilitated by the system to use.

### DETAILED DESCRIPTION

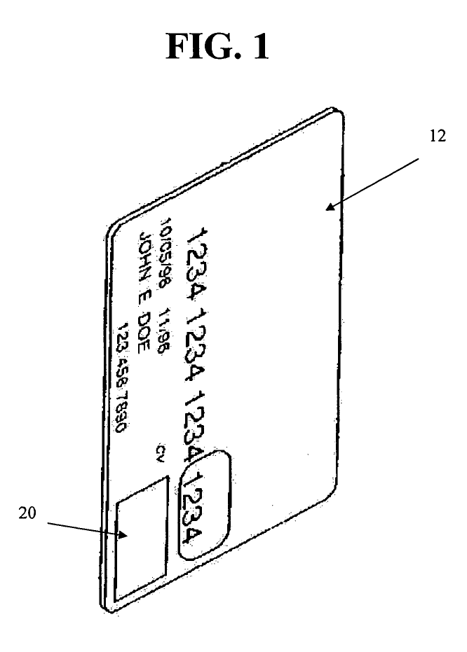

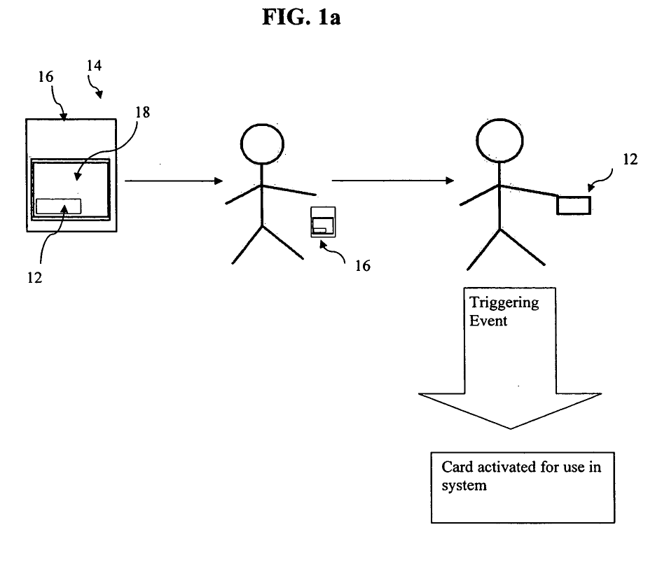

To use the system of the present invention, a consumer 10 must obtain a card 12. Cards 12 may be made available or distributed to consumers in any acceptable manner, such as being made available with a product at a point of sale, distribution of a sample product, by direct mail, in connection with a purchasing incentive, in-person distributions, by special promotions, or by any other means. As shown in FIG. 1, a card 12 comprises a microchip 20 such as an RFID chip for electronically storing information. The microchip 20 may be visible on the card 12, or may be imbedded within a card 12 so that it is not visible.

As represented in FIG. 1a, a consumer can receive a card via a product where the card is disguised by the packaging, as described in U.S. Patent Publication No. 20030070338, and U.S. Pat. Nos. 5,489,123, 5,308,119, and 6,042,149. Thus, the consumer is not aware of the precise nature of the incentive item attached to a product the consumer is purchasing until the consumer purchases the product and removes the packaging. Ideally, the consumer would not realize there is a special incentive enclosed or affixed to the product or product package until the consumer has already made the purchase and began using the product. As represented in FIG. 1a, the consumer purchases the product 14, removes the packaging 16, and discovers the card 12. The card 12 may be activated for use in the system of the present invention by participation in a consumer survey, as described in U.S. Patent Publication No. 20030070338, and U.S. Pat. Nos. 5,489,123, 5,308,119, and 6,042,149. Examples of purchasing incentives include, but are not limited to, a preselected amount of cash associated with a card, a coupon, or a free product.

Cards 12 could be placed on or affixed to a product package 16, in some cases disguised, such as by labeling 18, such that consumers do not realize that the cards are there until they go to use the product. At that point, the card 12 will entice the consumer to respond to a consumer survey or consumer research program by indicating that in return for the consumer's cooperation, the card can be activated and the consumer given cash or other incentive. When a card is disguised, it will not influence the consumer's purchasing decision. Thus, the ability to obtain a premium will not skew purchasing data toward particular products.

The cards 12 may be placed in or upon product packages 16, or distributed as hand-outs in retail stores or at special events, or sent to consumers via mail, whether traditional direct mail or any form of electronic mail. In an illustrative embodiment, consumers can only activate the cards, or access the cash or other incentive available via the card, once they have participated in a survey or consumer research program. Upon participation, the microchip on the card and the corresponding card account is activated.

In an illustrative embodiment of the present invention, consumers can retain the cards to become a part of a consumer research panel, where the cards 12 are reactivated each time the consumer participates in a survey or market research program. Alternatively, consumers can retain the cards 12 and use the cards 12 for their retail shopping without participating directly in a survey, and receive all of the benefits discussed herein.

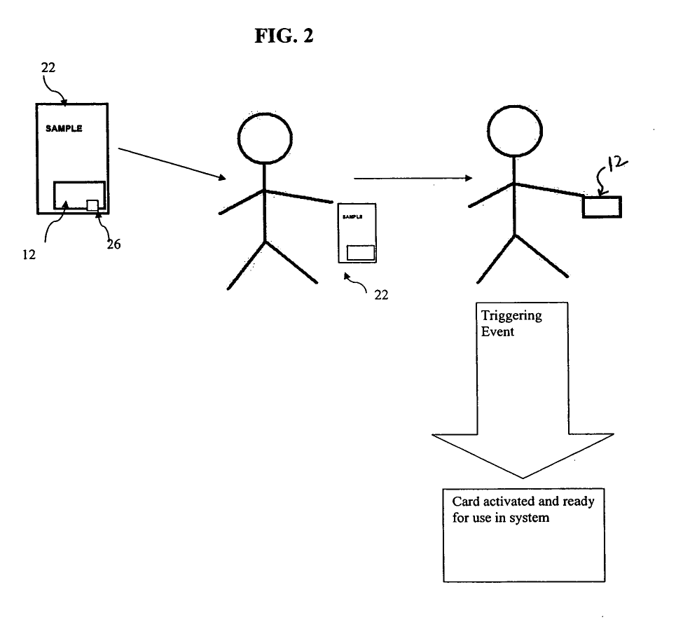

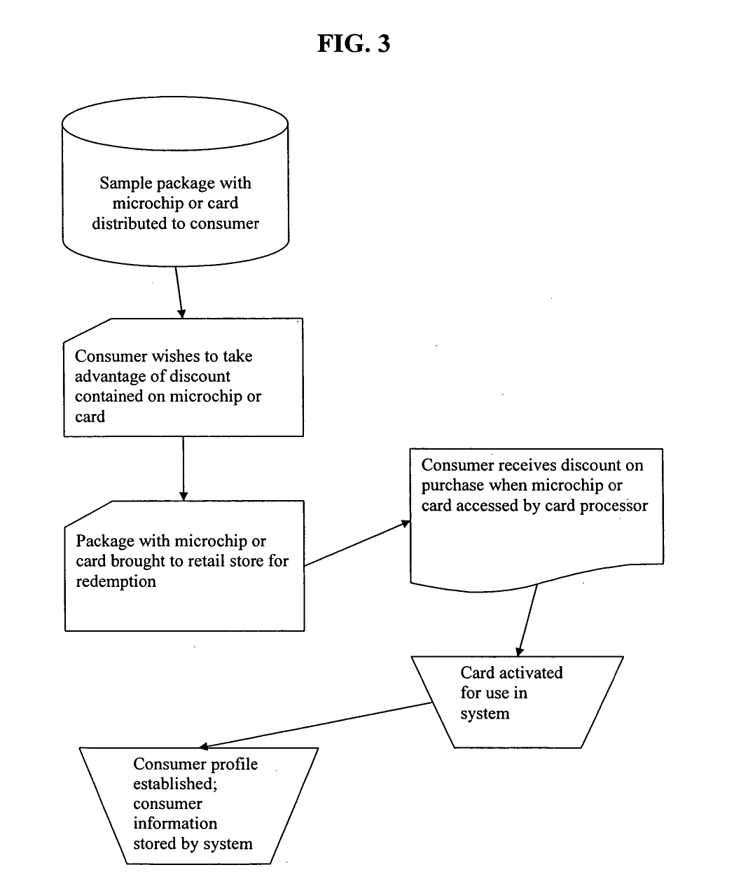

In another variation of the present invention, as represented in FIGS. 2 and 3, microchips 20 are placed on or within packages 16 of sample products 22 distributed to consumers, or cards 12 having microchips 20 are affixed to the packaging 16 of sample products 22 that are then distributed to consumers. Microchips 20 are within the meaning of the term cards 12 as used herein. The computer microchips 20 can contain any information relevant to that sample product 22. If a consumer later wishes to purchase the sample product, the consumer can bring the product package 16 or card 12 having the microchip 20 to a retail store and, during checkout, the card reader is activated and accesses the information stored on the card. The consumer then receives a discount on the purchased product. The card processor also retrieves the information stored on the computer microchip relating to the product sample. Accordingly, by using the system of the current invention, companies can monitor product sampling effectiveness by capturing information regarding product sample use and/or conversion to purchase of the new product.

Rather than directly providing a sample product, the card may also be loaded with enough cash to enable the consumer to purchase a product that a manufacturer wishes to have the consumer try. Hence, a client such as a product manufacturer, by using the system of the present invention, will enable a consumer to receive a sample and/or free product by providing the consumer with funds on the card to pick up the product in its normal retail environment, and purchase the product using the funds that have been pre-loaded on the card by the manufacturer.

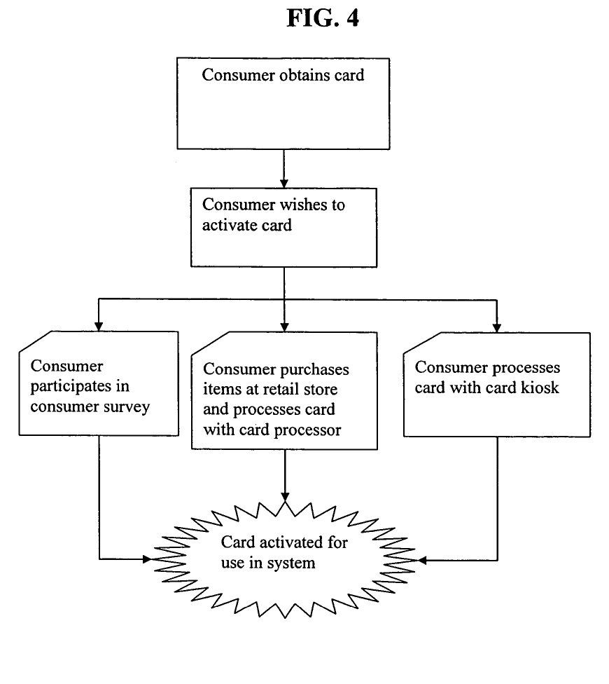

Card activation takes place upon the occurrence of a “triggering event”. As used herein, a “triggering event” encompasses any step by which a card is converted from an inactive status to an active status for use in the system. This is shown schematically in FIG. 4. A triggering event that results in card activation can take place in person, telephonically, by computer over the internet, by e-mail, via a personal digital assistant (PDA), or by other acceptable means. A triggering event could be, by way of example and not by way of limitation: participating in a consumer survey; visiting a participating retail store, purchasing items, and processing (inserting, swiping, scanning, waving, etc.) the card during checkout; by entering information into an internet website; or, by processing the card via a card kiosk. The consumer may participate in a survey via telephone, internet, direct mail, e-mail, on-site at a central location, at a card kiosk, or via another acceptable medium. After a triggering event, the consumer can use the card and receive the benefits of the system of the present invention.

It is appreciated that a consumer may provide personal or demographic information when activating a particular card, or may choose to use a card anonymously, without providing any personal or demographic information. Regardless of whether a consumer provides personal information, the system of the present invention still tracks, as discussed in further detail below, the purchasing habits of the consumer using the card. Thus, the same purchasing information is collected regardless of whether personal or demographic information is provided during a triggering event or not.

To illustrate, a consumer may obtain a card, participate in a consumer survey by providing personal information, and thereby activate the card. In that case, some of the consumer's personal information and consumer preferences may already be obtained by the system, and it may be possible to identify the consumer. In the alternative, a consumer may receive a card such as by shopping at a retail store having a special promotion. The card may comprise a special code on the microchip, as well as a printed serial number on the face on the card. The consumer may purchase items at the store, and process (insert, wave, swipe or scan) the card during checkout. Processing (inserting, waving, swiping or scanning) the card will, in that case, be the triggering event activating the card.

After a triggering event, a consumer profile 42, also referred to herein as a “profile,” is uniquely created for each card in the central computer 36. The profile 42 may be a computer software application, a data file, a database, or any combination thereof. The profile 42 collects all of the information relating to a consumer (if provided), a consumer's purchasing preferences, and/or the purchasing activity of a consumer using a card. In addition to being a resource for collecting information for use in consumer marketing research, the profile 42 may be the consumer's general account for the system, collecting personal preference information necessary for a consumer using the system. Each profile 42 created is uniquely identified with the code on the microchip 20 of a particular card. Thus, any time a particular card is used for purchasing items, the information pertaining to the purchased items is captured in the corresponding profile 42.

Where a consumer activates a card by providing personal or demographic information, or participates in a consumer survey, the profile 42 may contain identifying information regarding the particular consumer using the card. Where personal information is provided for a profile 42, the system will be able to target certain incentives or other information personally to the identified consumer. The profile 42 may be used to collect and store mailing, payment or billing information.

If the card is activated anonymously, without the consumer providing any personal or demographic information, a profile 42 will be created corresponding to the code on the microchip on the card. The consumer's purchasing activities are still automatically tracked each time the consumer uses the card, and the profile 42 will capture all information related to the consumer's card and purchasing activity. If the anonymous consumer uses the card at, for example, a card kiosk discussed below, the anonymous consumer may still receive invitations to participate in consumer surveys or focus groups without providing any personal information that the consumer feels may compromise their privacy. Even without participating directly in any surveys or other consumer research, the consumer is still participating in research simply based upon purchasing choices tracked in connection with use on the card in the system.

Where personal information is not provided during card activation, the system may be provided with a means for checking that a card is being used consistently by a particular consumer. For example, once a card is activated via a triggering event, and a profile is created corresponding to the code on the microchip of that card, when the consumer uses the card, the consumer may be required to identify themselves by utilizing a biometric device. The consumer may be required to provide a fingerprint or retinal scan when using the card to purchase items. In that case, the retail checkout area or a card kiosk may be provided with a biometric scanner or similar device.

The profile 42 is used by the system to monitor, record, process and/or analyze consumer purchases and purchasing habits, or other purchasing information, associated with a particular card 12. In this way, the profile 42 captures consumer attitudes and behavior. A profile 42 may contain information such as personal consumer information and demographic information (if provided); billing information (if provided); dates of shopping trips; items purchased; coupons received or used; brand preferences; responses to a consumer survey; or other relevant information. The central computer 36 can store and/or access the profiles 42 for all cards in the system.

Card activation is preferably tied to participation in a consumer survey, whereby completing the consumer survey is the triggering event. In this way, the system gathers information from the consumer. For example, the consumer may be required to answer a series of questions regarding purchasing preferences, demographic information, household information, brand recognition, shopping history, ratings on specific product attributes, etc. It is contemplated that, during card activation, at least some demographic information is collected for use in the system. Consumers are permitted to be involved in the system at any level with which they feel comfortable.

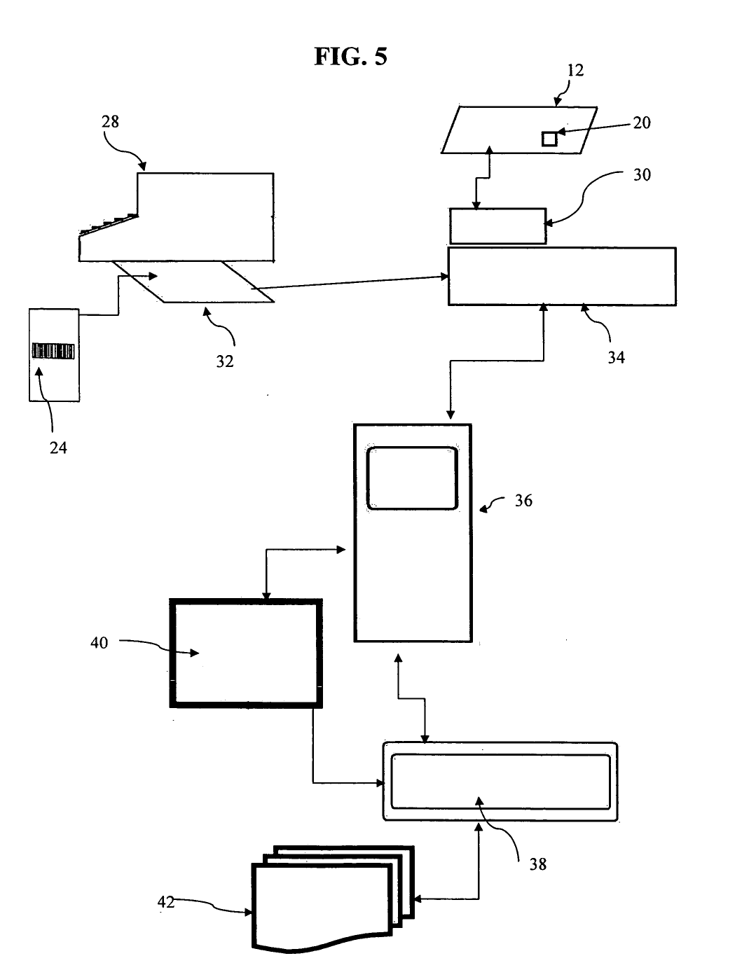

According to the system of the present invention as illustrated in FIG. 5, checkout areas of retail stores, for example cash registers 28, are provided with a card processor 30. As used herein, “card processor” encompasses card readers, transmitters, or any other device or modality that can process, access, read, store, or analyze the information stored on a card. The card processor is adapted to process information stored on the microchip on the card, information from the central computer, or any other information made available to the system. As used herein, the term “process” encompasses, but is not limited to, the ability to examine, process, access, identify, record, store, analyze, read, or write information. As used herein, the term “processing” encompasses, but is not limited to, examining, processing, accessing, identifying, recording, storing, analyzing, reading, or writing information. The card processor 30 may be equipped with a computer processor capable of processing computer software and data files. The card processor 30 may also write data to the cards 12 for storage on the microchips 20. In an illustrative embodiment of the present invention, a retail store has a computerized scanner or reader 32 that may be associated with the retail store's cash register system 28, which scans or reads the Universal Product codes (UPC), an Electronic Product code (EPC), or bar codes or any product codes 24, collectively referred to herein as “product codes,” associated with products being purchased by a consumer. A product code 24 encompasses any coding system for keeping track of particular products, where each product has a unique code. The card processor 30 of the present invention can be in communication with the computerized scanner or reader 32, and can thereby access information regarding the items purchased by a consumer and recorded by the scanner or reader 32. In this manner, the products purchased by a consumer with a card are easily identified.

The card processor 30 may, among other functions, access any information stored on the microchip on the card, identify any items purchased by the consumer, and record information about the consumer's purchases. When information is accessed by the card processor 30, either directly from the card 12 or in connection with the items purchased and identified when using the card 12, such information may be stored in the card processor 30 such as in a card processor memory 34 associated with the card processor 30. The information may also be accessed by the card processor 30 by instantaneously contacting a central computer 36 via a computer network. The internet is just one example of a computer network, but any intranet or extranet or other network adapted to provide communication between the card processor 30 and the central computer 36 is acceptable. The network may be wired or wireless.

The central computer 36 may be equipped with a memory capacity for storing information, computer software and/or data files in order to process the information obtained from the cards, as well as to perform set routines, analysis, or calculations related to such information. The central computer 36 may comprise, for example, a central memory 38 for storing information sent to, processed, or accessed by, the central computer 36. The central memory 38 may provide storage for the information accessed when the cards are read, and may also store any additional information for use by the system. The central memory may be housed within the central computer 36, or may be physically separate from and in electronic communication with the central computer 36. Any references to storing or the storage of information in or to the central computer 36 encompass storage in the central memory 38. Any element of the present invention in communication with the central computer 36 would necessarily be in communication with the central memory 38, and would be able to access any information stored in the central memory 38.

The central computer 36 may further comprise or may have access to a database 40 comprising information regarding every product code 24 and all information associated with the specified product codes 24 for each product that has a product code 24 assigned to it. The database 40 may be stored in the central memory 38. Although illustrated separately in the Figures, it is appreciated that the central computer 36 may house the central memory 38, as well as any data files or databases such as database 40, therein.

If the card processor 30 is equipped with a computer or card processor memory 34, it can receive and compile all information retrieved from the cards 12 used by consumers in connection with the associated card processor 30. The information gathered can be used for various purposes, as discussed in more detail below. The card processor 30 may be connected to or otherwise in communication with the central computer 36, which can access and store information from a plurality of card processors 30. The communication between the card processors 30 and the central computer 36 could take place over the internet or any other computer network.

The information collected by the card processor relating to purchases made using a particular card when purchasing items is collected in the central computer 36 in the profile 42. Thus, in addition to comprising demographic or other information relating to a particular consumer, the profile 42 is also a repository of information relating to items purchased by a consumer using a card during shopping trips. The information collected in the consumer profile 42 thus reflects, among other things, a consumer's purchasing attitudes, behaviors, habits and preferences. The consumer profile 42 is therefore an invaluable resource for conducting consumer marketing research, as discussed in more detail below.

When a consumer uses a card 12 to shop at a retail store, for example, at checkout, the consumer will process the card via the card processor 30, which may include any of inserting, swiping, scanning, or simply waving the card across or adjacent an area of the checkout or card processor adapted to recognize and read the card's microchip. Scanning, as used herein, would encompass a consumer simply having the card, without actively removing it from their purse, pocket, or wallet, anywhere adjacent or within the reading capability of a device of the system for processing cards. This may take place using one of the card processors 30 at or near the checkout area. If the card has not yet been activated by a triggering event, processing the card 12 via the card processor 30 will act as the triggering event, the card will be activated, and a profile 42 corresponding to the card will be created. Upon accessing the card, the card processor 30 will access any information stored on the microchip on the card. The card processor 30 will further record all of the purchases that the consumer made on that shopping trip when the items have been identified.

The card processor 30 may then store that information in the card processor memory 38. The card processor 30 may also communicate with the central computer 36, transfer the information regarding purchases made in connection with the card 12 to the central computer 36 for storage in the profile 42, and access any information relating to the profile 42 corresponding to the card 12. Alternatively, the information regarding products purchased can be transmitted via the internet or any other computer network to the central computer 36, which will track, identify and store information regarding each of the products purchased using a particular card 12, in the consumer's profile 42.

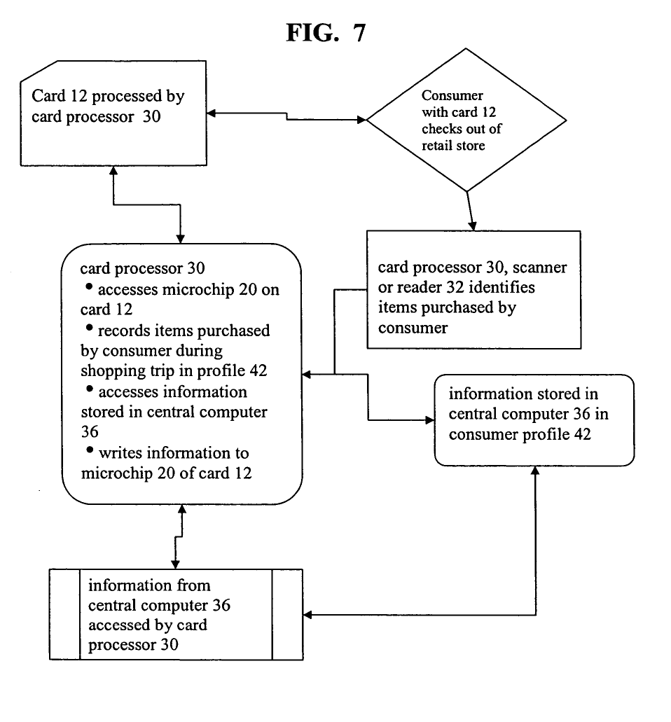

In the embodiment shown in FIG. 5, the card processor 30 is in electronic communication with the retail store's checkout and cash register system 28, so that a list of the items identified (scanned) during checkout can be accessed directly by the card processor 30. Identifying information about the products purchased during a shopping trip, including specific Stock Keeping Units (SKUs), Electronic Product codes (EPCs), or any other product codes 24 may be stored in the card processor memory 34, in the central memory 38 of the central computer 36, and/or on the microchip 20 on the card 12. The card processor 30 is further capable of writing information directly to the microchip 20 on the card 12, so that the card 12 carries with it all or some of the information stored in the corresponding profile 42. In that way, when a card 12 is used at another participating retail store, or when a consumer visits a card kiosk at any participating location, processing the card with a card kiosk, card processor or other acceptable card reader of the system will provide all of the information captured in the profile 42. The card processor memory 34 will record the products, that were purchased and list the specific product codes 24 of the products purchased on that particular occasion. Additional information may also be captured, such as price paid, date code, date and time of purchase, etc. All information may be transferred to the central computer 36 and stored in the consumer's profile 42. This is shown schematically in FIG. 7.

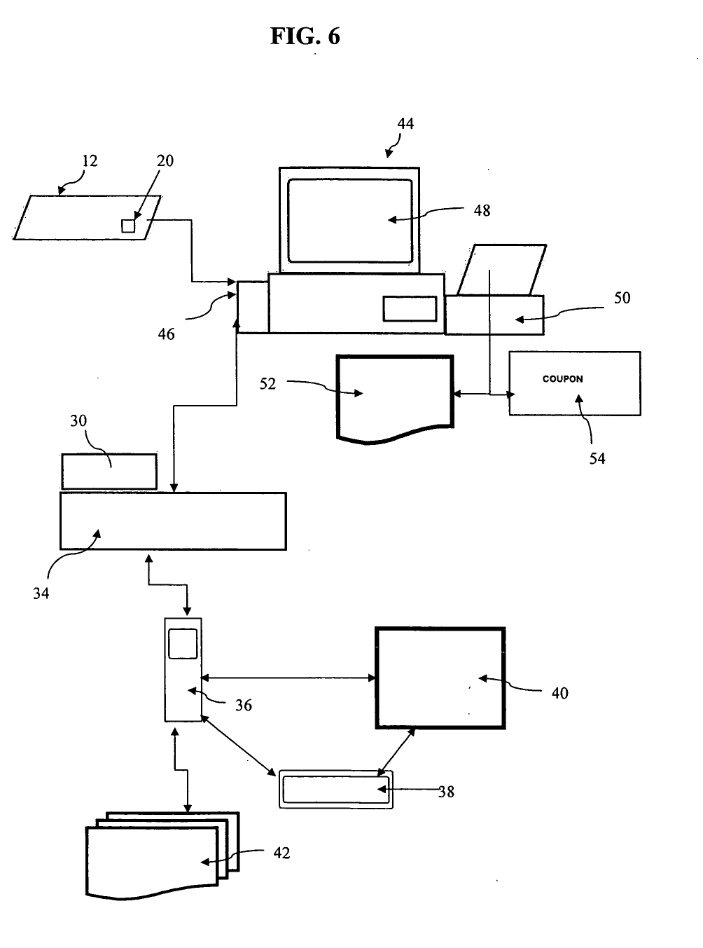

As shown in FIG. 6, the present invention may include a card kiosk 44 that consumers can utilize at a retail store or other participating location. The card kiosk 44 can take any of several forms, including an ATM-type machine, a monitor, card reader, and keyboard, or a simple scanner/printer device, all such variations of which are contemplated as being within the scope of the card kiosk 44. In an illustrative embodiment, the card kiosk 44 comprises a scanner or kiosk card reader 46 for processing a card and adapted to access the data stored on the microchip on the card, a kiosk video display or monitor 48, audio capabilities, and an attached or built-in printer 50 for providing printed materials to a consumer. As used in connection with references to the card kiosk 44, a kiosk card reader 46 may be any means by which information stored on the microchip on the card 12 may be accessed. The card kiosk 44 may also be equipped to communicate with the central computer 36 having a central memory 38, a database 40, and access to at least one profile 42, so that once the card kiosk 44 reads a particular card 12, the card kiosk 44 is able to access information and identify the items previously purchased by a particular consumer. Each profile 42 may be unique to a particular consumer and card 12, and therefore can be useful in targeted shopping or advertising. In order to store and access information, the card kiosk 44 may be connected to the central computer 36 via the internet or any other computer network.

When consumers enter a retail store, they can visit the card kiosk 44 and process the card via the card kiosk 44, in order to, for example, activate the card or access information from the consumer's profile. As used herein, the term “process” encompasses, but is not limited to, any of inserting, swiping, scanning, or simply waving the card across or adjacent an area designed to read the microchip on the card. The card kiosk 44 may then access the central memory 38, retrieve information associated with that particular card such as the consumer's profile 42, and identify items or categories of items previously purchased by the consumer. The card kiosk 44 may then print out any of a number of different potential lists 52. For example, the card kiosk 44 could provide a list of certain products in certain categories that the consumer purchased previously. The card kiosk 44 may also provide a list of all products purchased during previous shopping visits. The card kiosk 44 may also generate a list of money saving offers or coupons that the consumer qualifies for or may be interested in, based upon previously recorded shopping habits or patterns. The consumer can take the list or coupons to use while shopping. Having the list in a tangible form, rather than just stored in a card, allows the consumer to review the coupons or other offers, in an accessible and convenient manner.

The lists 52 generated by the card kiosk 44 may be adapted to provide specific details about products, such as where certain products could be found within the retail store, by aisle number and shelf location. The lists 52 may also comprise information informing the consumer of special pricing available to the consumer at checkout. The list can also include unadvertised store specials. Moreover, the lists or coupons can also contain advertising, for example on the back of such generated lists or coupons.

The consumer may also manage the profile 42, and any of the information associated therewith, via the card kiosk 44. Thus, upon processing the card 12 at the card kiosk 44, the consumers profile 42 may be accessible. All of the activity relating to the management, accessing, administration, control, manipulation, alteration, entering, or deleting of information associated with the profile 42 is within the meaning of the term “manage” as used herein.

Advertising space can be sold on printed instruments, such as lists or coupons, generated by the system, or on the internet website, as a means for distributing promotional information or coupons for products that consumers are likely to purchase on a future shopping trip. Advertising space can also be sold to provide targeted advertisements directly on a video monitor located on the kiosk at the store entrance. Advertisements could also appear on monitors at selected locations throughout the store. The advertisements can be synchronized, so that a particular advertisement targeted to a particular consumer will be displayed when the consumer is adjacent a particular display carrying the product being promoted.

The card kiosk 44 may also print out store coupons 54 for redemption during a shopping trip. The store coupons 54 may be printed by the card kiosk 44 based upon past purchasing information as collected by the card kiosk 44 and stored in a profile 42, or stored directly on the computer chip on the card 12.

The card kiosk 44 may be programmed to automatically generate coupons based upon a consumer's prior purchasing activities. Thus, coupons and discounts for the same or competing brands of products can be targeted directly to consumers. These coupons or discounts could be for items the consumer has purchased previously, or for items that are competitive to some of the products purchased previously. Manufacturers may want to entice consumers who buy a competing brand on one occasion to choose the manufacturers' brand on the next shopping occasion, for example. Consequently, they may offer a discount on the next purchase through the card system of the present invention.

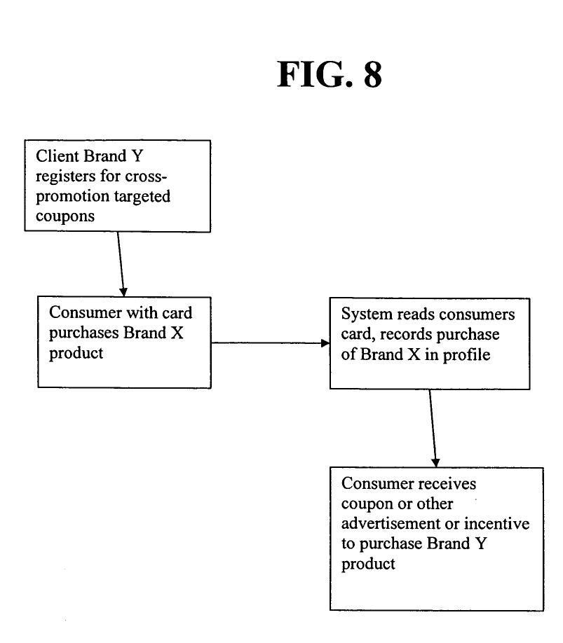

For example, if a consumer bought Brand X ketchup one week, she could be enticed with a coupon for competing Brand Y ketchup on her next store visit. Information relating to product categories could be sold or rented to manufacturers. For example, a manufacturer of Brand Y ketchup could purchase the ketchup category on the entire system for, say, a week, and consumers with cards using the system would receive only Brand Y coupons for that time period. This is shown schematically in FIG. 8.

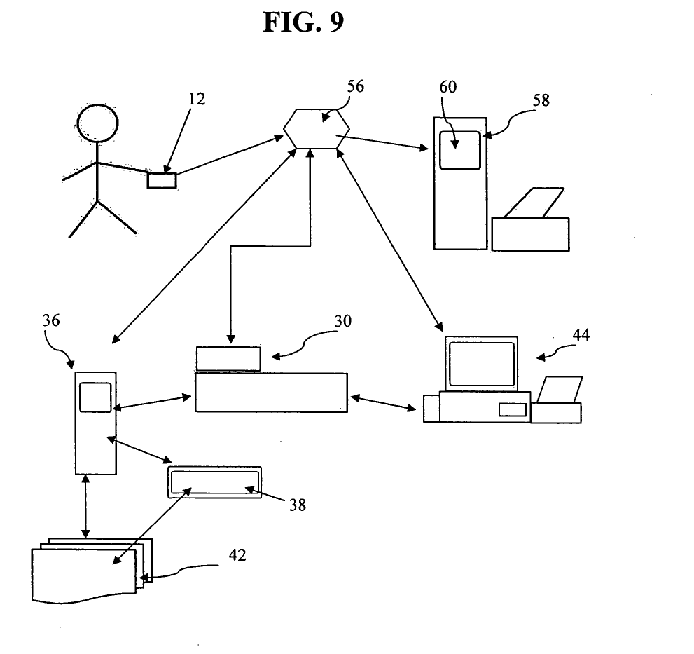

Even if a consumer does not physically visit the card kiosk, the system is designed so that if a consumer enters the store with the card, the card is automatically read by a card reader 56 placed at or near the entrance to the store, as shown in FIG. 9. This card reader 56 communicates with the central computer 36 and central memory 38 and can provide special offers tailored specifically to that consumer based upon prior purchasing habits. The consumer may also be exposed to custom advertisements during their shopping trip when they pass by certain product displays 58. These advertisements can be delivered via electronic video monitors 60. The product displays may also be equipped with audio and/or printing capabilities.

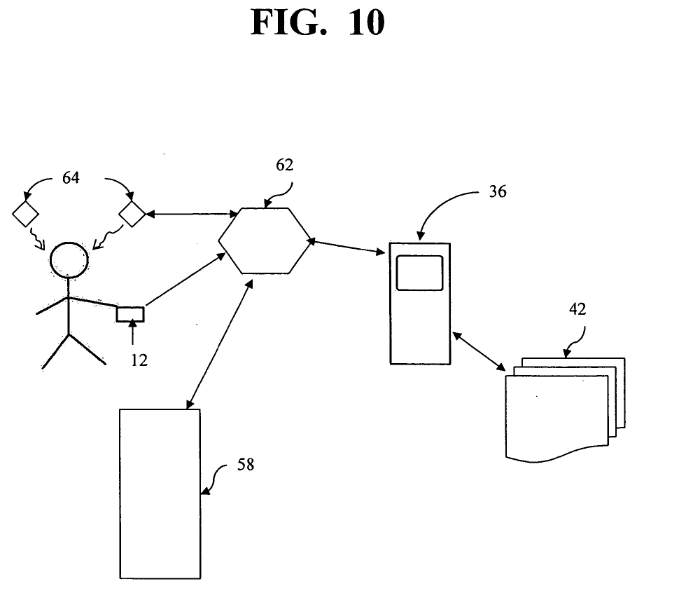

As shown in FIG. 10, advertisements may also be delivered to a consumer via hypersonic-sound (HSS) such as the technology disclosed in U.S. Pat. No. 6,229,899, and employed by American Technology Corporation, and discussed in Forbes® magazine's September, 2003 issue. HSS employs ultrasonic sound waves transmitted by emitters to create audible sound when ultrasonic beams intersect. The card 12 sends a signal to a receiver 62 indicating that a consumer is proximate to a certain product display 58. The card reader 56 is in communication with the central computer 36, and is able to access data from the profile 42. The system is designed to assemble information relating to the profile matching the accessed card, such as whether the consumer qualifies for a special money-saving or other promotional offers. The system then activates a HSS emitter or set of emitters 64 to send an HSS audio signal containing an audio message directly to the consumer.

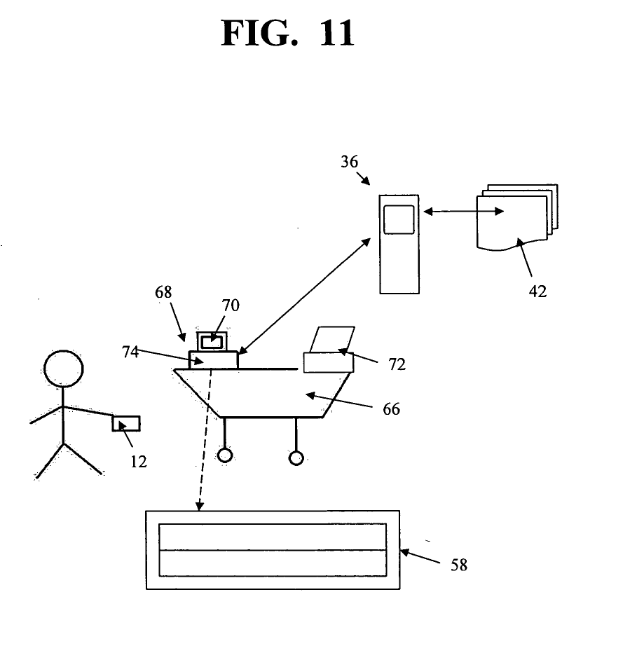

In another embodiment of the present invention, as shown in FIG. 11, shopping carts 66 are provided for use by consumers comprising shopping cart processors 68. The shopping cart processor 68 is adapted to operate in a similar manner to the card kiosks, discussed above. The shopping cart processor 68 is able to access and read the information on the card 12. The shopping cart processor 68 is in communication with the central computer 36 via a wireless network, and can therefore access the information in the profile 42 associated with the consumer's card 12. Thus, direct feedback can be provided to a consumer's shopping cart during a shopping experience.

The shopping cart processor 68 may be equipped with video monitors 70, which can provide targeted messages or advertisement to the consumer regarding, for example, product specials or discounts available as the consumer shops. Targeted commercials may be displayed on the video monitors 70 based upon information accessed by the shopping cart processor 68 in a consumer's profile.

In addition, the shopping cart processor 68 may be adapted to communicate with product displays 58 located throughout the store. When the shopping cart processor 68 is in proximity to a display 58, the display 58 may be activated to provide a targeted message or advertisement to the consumer, based upon the information in the profile 42, or information provided by a manufacturer. The shopping cart processor 68 may also be used to activate HSS emitters to deliver advertisements as a consumer moves about a store. The shopping cart processor 68 may also be equipped with a printer 72 for providing printed materials such as printed lists, coupons or other special offers to the consumer, like the card kiosk previously described.

In another embodiment of the present invention, the shopping cart processor 68 may also be equipped with a reader 74 capable of reading product codes 24 of items placed in the shopping cart 66. The reader 74 is in communication with the central computer 36. After the product codes 24 are read, product information may be conveyed to the consumer via the video monitor 70 or printer 72 regarding, for example, complimentary products, competing products, coupons, or other consumer information relating to the products. The shopping cart may also be equipped with audio capabilities, such as an audio speaker, or HSS emitter, for sending direct audio messages to the consumer using the shopping cart.

The shopping cart processor described herein makes it even more effortless for a consumer to benefit from the present invention while the consumer is shopping. Using the system of the invention, consumers receive targeted offers as they shop as well as targeted advertisements as they shop based upon the consumer's purchase history, or based upon what the consumer places in the shopping cart during a given shopping trip.

Additionally, the shopping cart processor 68 can read product codes 24 of products placed in the shopping cart, and provide a list on the video monitor 70 of items placed by the consumer in the cart, as well a running list of product prices. This allows consumers to have a better understanding of their shopping experience, without actively adding up prices.

The shopping cart processor 68 may further be adapted to communicate with the card processor 30. Thus, once the shopping cart processor 68 reads and logs each product code 24, this information can be communicated to the card processor 30. During check-out, the card processor 30 will process the items purchased by the card user. The card processor 30 is designed to communicate to a cashier or the cash register system the total price of the items in the shopping cart 66. The consumer need only pay at this point. If funds have been placed in the consumer's profile 42 for later redemption, the card processor 30 or cash register 28 can deduct sufficient funds to cover the purchases. This system is much more convenient and efficient than current checkout systems, because all of the products placed in the cart are already registered such that the consumer should only need to pay, not have each item re-scanned at the register.

Delivery of advertisements according to the present invention allows the opportunity for efficient testing and targeted market research. The advertisements delivered to consumers may be tested via the system of the present invention by playing a series of different advertisements for the same products to different consumers. Using such a technique, the system will be able to track consumer exposure to advertisements, and the effectiveness of the advertisements in enticing a consumer to purchase an advertised product.

By way of example, there may be several different advertisements that a manufacturer might want to test for advertising a particular product. Consumers who have a card of the present system and who have the manufacturer's desired purchaser profile will be exposed to one of the advertisements when the consumer is at a pre-selected location for receiving the advertisement. The system will monitor which customers were exposed to which version of the advertisement, and which advertisement resulted in the most purchases of the manufacturer's advertised product. This is a considerable improvement in advertising testing compared to what is currently available.

At checkout, consumers will scan, insert, swipe or wave their card past the card processor 30, and will receive the discounted price for all items purchased that were offered at a discounted price. As discussed above, the card processor 30 or card processor memory 38 will also access and store information regarding the items purchased by the consumer on that particular shopping trip. Alternatively, the information may be transmitted via the internet or any computer network to the central computer 36 and central memory 38 that stores all of the information regarding the card used and the items purchased in profiles 42.

The system of the present invention could also be adapted to be a loyalty program for a selected store chain. In that case, the cards could only be used at the selected chain. In the alternative, cards may be used at any store in a chain that has the appropriate kiosk and other card equipment needed in order to offer the system.

If the system of the present invention is adapted for a specific store chain, it may be arranged so that the store does more than simply deduct money from the selling price of the products that are offered at a discount. In addition to any savings, the consumer could have cash value, or points, loaded onto the card that can be spent on future shopping trips at the same store. This gives consumers a reason to visit the same store again. It also makes consumers feel like they are receiving something in return for shopping at a particular store.

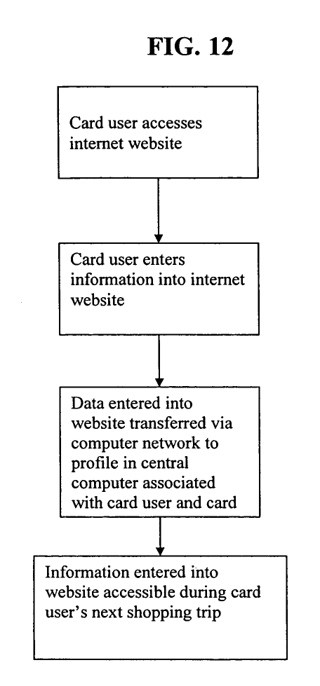

The system of the present invention may also be adapted so that consumers can visit an internet website designed for use with the cards 12 of the present invention, as shown schematically in FIG. 12. Consumers can log on to such a website, access and manage the consumer's profile 42, and any information associated with the profile 42 or otherwise contained therein. Such information may comprise the consumer's billing information, any changes to the consumer's demographic information, the consumer's preferences, or information relating to consumer purchases. For example, the consumer can select the items that they seek to purchase on their next shopping trip. Consumers log in either by registering their card and entering a password to gain access, or by using a card processor 30 that can be attached to (or housed inside) their computer. Once access to the website and a consumer's profile 42 is obtained, consumers may enter their desired order directly on-line and the system will immediately determine which discounts they will qualify for. This information may be stored for the consumer in the consumer profile 42 until the consumer visits a card kiosk 44 or card processor 30 at a local store so that such profile 42 information is accessed. The internet website can be used by the consumer to keep a running list of items needed the next time the consumer shops. In addition, orders can be placed for direct shipment to the consumer through an on-line shopping arrangement. All of the activity relating to the management, administration, control, manipulation, alteration, entering, or deleting of information associated with the profile 42 is within the meaning of the term “manage” as used herein.

At the card kiosk 44, once the card is read the consumer can print out a shopping list along with the list of applicable coupon offers or discounts. At checkout, the consumer may again swipe the card, or otherwise have the card accessed by a card processor, and all purchases will be recorded and money saving discounts accounted for. The consumer will either have a certain amount of money deducted from the total bill, or can have funds (cash or points) loaded into the microchip card for future use.

Having the card kiosk 44 available at the retail store where the consumer will be shopping has several advantages. When consumers are informed by a printed document of discounts on items as they begin their shopping experience, it is much more likely that the consumer will purchase the discounted items than if they are informed of discounts when exiting a store. There will be a much higher coupon redemption rate using the invention of the present system. In addition, consumers do not have to remember to bring coupons with them to the retail store, because as long as they have their card they will receive or be notified of coupons as they begin their shopping experience. Another benefit of the system of the present invention is the ability to print a consumer's shopping list on site at the store.

Card kiosks 44 located at a retail store can print out coupons that can be used at any retail outlet containing the appropriate card kiosk and card processing (or card reading) equipment, to create a delivery system that is highly targeted. Thus, the system of the present invention could replace the free standing inserts (FSIs) in weekend newspapers. By using the system of the present invention, consumers would be telling retail stores and manufacturers what they need or want to purchase. Based upon a consumer's lists, special coupons can be printed out at kiosks.

It is contemplated that consumers would not be required to provide personal information to use the system. Providing personal information would be optional. However, consumers who voluntarily provide demographic and other personal information could qualify for additional promotional offers, bonuses, or consumer research programs.

Consumers who indicate that they are interested in participating in consumer research programs may register their cards with a service that is provided in connection with the system. Registration can be accomplished by any means, including in person, by telephone, by mail, through internet sign-up, at a store's checkout counter, or at any location equipped with a card reader that can recognize a consumer who would qualify for the appropriate research program. If a consumer initially registers a card, the consumer can be offered the opportunity to participate in consumer research programs by means of a print out offer for them to participate, or by periodic direct contact based upon the consumer's buying patterns. The offer to participate in a consumer research program can be transmitted to the consumer via the card kiosk, in person, by telephone, by mail, via the internet or any other suitable means. The offer to participate can be presented to the consumer at any convenient location, whether it be a concert, an airport, train station, vending machine, etc. By registering a card, a consumer will become eligible for additional promotional offers and for invitations to participate in future research programs. According to the system of the present invention, purchase patterns, and patterns of trial and repeat use of products, can be determined.

Distribution of the cards can take several forms, and provides for many promotional options. As discussed above, the cards can be affixed to, within, or otherwise on product packages, sent via direct mail, or handed out in stores or at special events in order to provide promotional offers for free products or other money saving discounts. Consumers would be informed that the cards contain special offers. In such instances, the cards themselves are being used as an incentive to stimulate sales of a product or service. Once the consumer has a card, the card can be activated and then retained by the consumer to be used according to the system of the present invention, at any retail location equipped with the appropriate card processors and card kiosks.

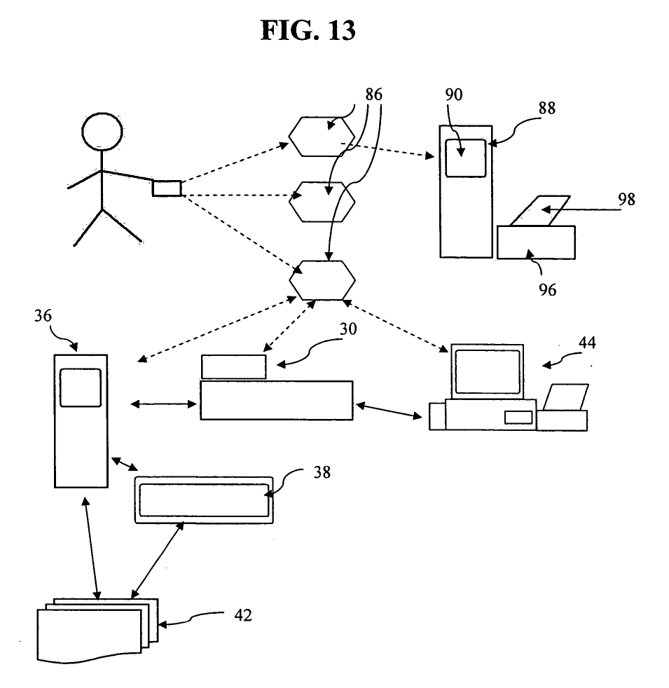

In another embodiment of the present invention, illustrated in FIG. 13, additional card readers 86 are placed throughout a retail store. The card readers 86 can access and read the information stored on the microchip of a card 12. The card readers 86 can be in communication with the card processors 30, central computer 36, central memory 38 and/or card kiosks 50, and share information with all of these components. When a consumer is shopping in a retail store, the card readers 86 can track the consumer. Terminals 88 are provided at selected areas in the retail store where consumers can receive information, based upon the card reader 30 accessing the card user's profile 42. Such information can be directed to, for example sale items offered at the store that relate to the card user's profile; available store coupons; items that may be of interest to the card user based upon shopping history; or similar advertisements or enticements.

When a consumer enters a retail store, her card is read via a card reader 86. The system automatically recognizes the consumer by accessing the consumer's profile 42 and prints out, either upon a consumer's request or automatically, at a printing station 96 for example, a customized list 98 of offers that the consumer is eligible for on the current shopping trip. The terminal 88 may also have a video monitor display 90 for displaying product or promotional information to the consumer. Thus, there is no need for the card user to actively access a card kiosk in this embodiment of the present invention. If the consumer is in a hurry and does not want to be actively involved, but still wants the benefits of the system, the consumer will still be recognized by the card reader as she enters or travels about the store. As long as the consumer is carrying her card with her, the microchip will be accessed by the card reader and the reader will send a message to the central computer 36 registering the consumer's visit on that particular time and date.

At the checkout counter, the consumer can either actively process her card with the card processor to see if she can benefit from any special offers that she may qualify for based upon what she is purchasing on that day, or the system can be set such that the reader of the card processor identifies the microchip stored on the consumer's card without the consumer making any physical effort to take her card out of her wallet or otherwise physically remove her card or waving or inserting the card in the card processor. As long as the card is read, the consumer will receive all of the benefits of the system either on her current shopping trip or on future shopping trips.

Card readers 86 may be spread throughout a retail store to automatically read the consumer's card, access the central computer 86, central memory 38 and/or profile 42 via a computer network, and identify which products the consumer might be interested in purchasing. The card readers 86 can be connected to video monitors 81 that provide a display to the consumer of advertisements for recommended products, or provide the consumer with special offers. The video monitors can be located adjacent special promotional displays. Consumers carrying cards who pass adjacent a display may trigger the monitor and have a special advertisement or offers presented to them on the spot.

For example, the card reader 86 reads a consumer's card, and accesses the central computer and the consumer's profile 42, and obtains information that the consumer purchased a specific brand of ketchup on her last shopping trip. When the consumer proceeds to the aisle or location of the store where ketchup is sold, the card reader 86 accesses the card and directs the monitor and optional printer 74 to display and/or prints a product promotion or coupon. Alternately an audio advertisement may be played using technology such as the HSS technology discussed in detail above.

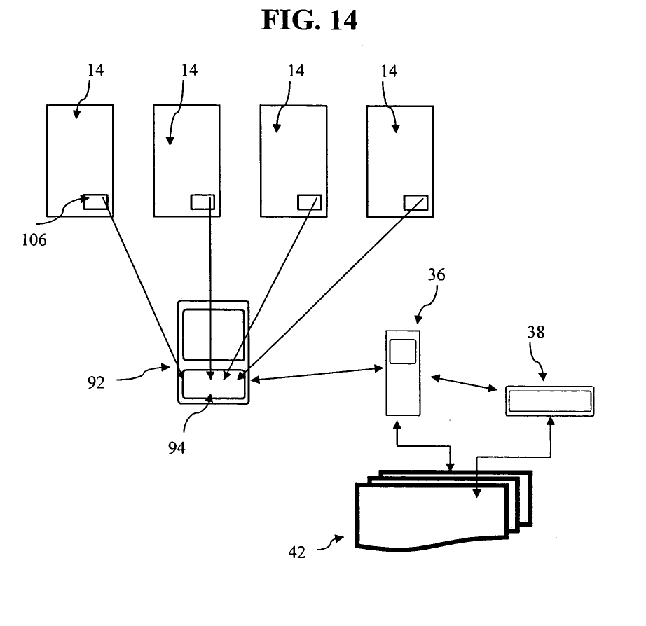

As shown in FIG. 14, a portable product identification system can be provided as part of the system of the present invention, in connection with a number of small electronic devices, such as, by way of example, a consumer's mobile phone, personal digital assistant (PDA), personal computer, or other similar portable electronic 92, referred to herein collectively as “portable electronic devices”. Products 14 are tagged with microchips 106 containing relevant information about the product, such as price; nutritional information for food; size; color; available discounts; or other relevant product information. During a shopping trip, consumers can access information regarding tagged products by holding a product's microchip tag near their portable electronic device, 92 equipped with wireless computer network access, such as wireless access to the internet, and a product tag reader 94. Information regarding a specific tagged product would be accessed via the central computer 38 which would link the product's microchip with the corresponding product code 24, resulting in the consumer gaining full access to all information that the manufacturer is willing to disclose to the consumer about that product. The information could further include advertisements and promotions. This can take place all within a few seconds while the consumer is standing in front of the retail display of the product that she is considering purchasing. In addition, the portable product identification system is adapted to communicate with a consumer's profile 42, and therefore inform the user regarding aspects of a given purchase, such as whether the tagged product is needed by the consumer, such as to replenish a product previously purchased and used.

As can be appreciated, although a card kiosk is shown in the preferred embodiment, a kiosk is not required for the system of the present invention to function. Regardless of whether a consumer visits a card kiosk, the system is devised so that the retail store's checkout device can read and access the microchip on the card, communicate with the central memory and associated consumer profile, and determine whether the consumer is entitled to any discounts or special promotions. If so, the consumer will receive the promotional discount, and their shopping bill will be reduced accordingly. In addition, if the consumer has set up a profile with a credit card or debit card to pay for items, funds could automatically be deducted from the consumer's account to pay for the items purchased on the shopping trip.

The system of the present invention can be equipped with measures to positively identify a consumer who might not be carrying the card, so that the card user can still take advantage of the system of the present invention. Any biometric identification means can be used to positively identify a card user. Thus, consumers can register, for example, their fingerprints or retinal scans with a central identification database that can be accessed by the card processors or card kiosks. The card processors, card kiosks or card readers may be equipped with fingerprint identification scanners or readers, or retinal scanners or readers. They can also be equipped with a keyboard, so that a consumer can enter a unique identifier code for allowing access to the consumer's profile. A consumer who is not carrying the card could, instead of swiping a card, scan her fingerprint or retina and still receive all of the benefits of the present invention.

The system of the present invention can also be adapted to access and utilize a consumer's payment information, such as credit or debit card information, checking information, or internet payment service accounts such as PayPal™, BidPay™, or similar services. A consumer can register individual payment information related to her card and card account, and could additionally register fingerprint or retinal identification information. Thus, the consumer's card, payment information, and identification means, would all be accessible by the system of the present invention. A consumer can thus access payment information directly through the system of the present invention, and such information could be retrieved via fingerprint or retinal scan. There would also be no need to carry the card, as the fingerprint or retinal scan could access the consumer's information, including payment information, for any purchases or other use. The fingerprint or retinal scan could also be tied to a password verification system. The consumer can access all information tracked by the system using the card processors and/or card kiosks of the present system. A similar system could be used at, for example, vending machines. The “cardless” aspect of the system of the present invention creates a very convenient system for consumers, who would not need to physically carry a card to access the system of the present invention.

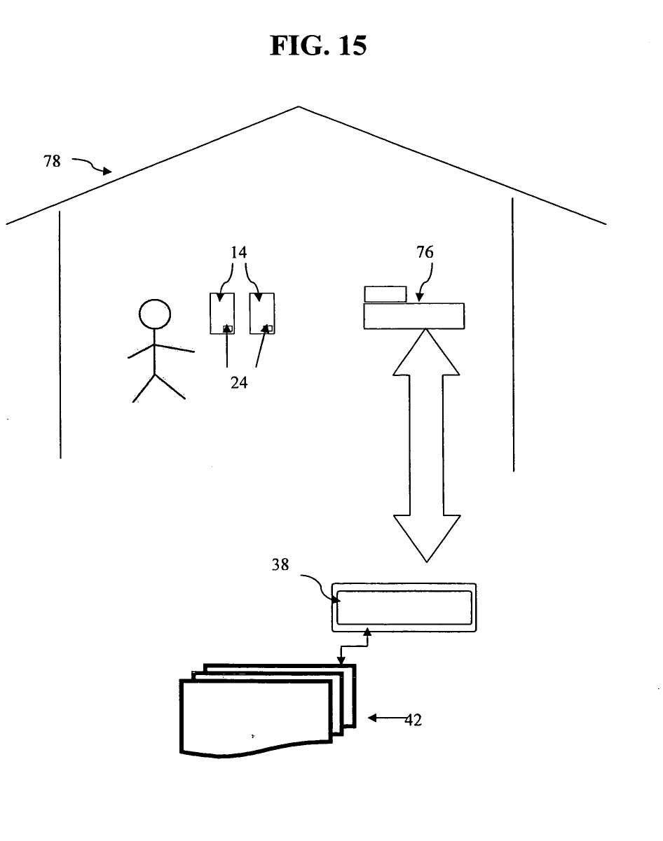

Consumers who are interested in participating in market research programs or consumer surveys may be asked to set up special transmitters and readers, such as RFID transmitters and readers, collectively referred to as market research processors 76, within their homes 78, as shown in FIG. 15. The market research processors 76 are adapted to read Electronic Product codes (EPC) or other product codes 24, for products 14 that are purchased and brought into the home 78. This is a significant improvement over other research programs that attempt to monitor purchase patterns of a household. The market research processor 76 is in communication via a computer network with the central computer 36, central memory 38 and/or profiles 42 of the system. Therefore, the consumer's purchasing behavior can be tracked at home, in a non-invasive and passive manner. Other systems, such as AC Nielsen's Homescan™ system, require the primary grocery shopper to remember to scan the UPC (barcode) of every product that they purchase and bring into the home. With that system, there is a great deal of room for error, because the consumer must physically pick up each product and scan it using a handheld scanner. Additionally, it is possible that other people within the home will make purchases and never pick up the scanner to record what was bought. Consumers who are participating in a program according to the invention will not have to remember to record or scan their purchases. The market research processors 76 will provide such features automatically.

The system of the present invention will provide an easier system than AC Nielsen's Homescan Panel for monitoring trial and repeat purchase patterns among households. The present system has the capability of reaching a much larger panel of consumers participating in a research program than the 61,500 households that are now used in the AC Nielsen Homescan Panel. By having a larger panel, the present system allows for faster response to clients' research needs (both behavioral and attitudinal research needs). Using the present system, clients will also be able to identify consumers who purchase a client's products as well as purchasers of the client's competitors' products. The present system will make it possible to monitor these purchasers trial and repeat patterns for specific products. The present system will also make it possible to recruit purchasers for participation in consumer marketing follow-up research studies.

In addition, in another aspect of the present invention, a particular card can be tied to a household account, having both a primary household profile for all of the members of a household, as well as individual household member profiles. A card may be associated with several corresponding individual household member profiles, each matched to a different individual member of a household. Each individual household member profile may be associated with a corresponding code or other means of positively identifying a household member, such as by registering biometric information, such as a fingerprint or retinal print.

Information relating to each individual household member will be processed by the system. Each individual household member profile may be established during a triggering event, by entering information into the card kiosk, by entering information into an internet website associated with the system, or by any other acceptable means. In this manner, the system of the present invention can determine which household member is using a card during purchases, and may process purchasing information such as when a purchase was made, from exactly which store a purchase was made, the time of the purchase, etc.

For a household account, a primary household profile may be established for the household card as a primary profile for all members of a household. Each household member may share a single card, with the card corresponding to individual profiles for each household member. When using a card to purchase items, a household member may utilize a code associated with that household member's individual profile, or the system may be provided with a biometric scanner or reader for positively identifying a household member.

Alternatively, each individual household member may be provided with a separate card that corresponds to both a primary household profile, as well that household member's individual profile. The individual household member's profile may be associated with a particular code or biometric information to identify the specific household member carrying the particular card. In tracking attitudes and purchase behavior for each member of a household using a card, the system provides a comprehensive view of household purchasing. The household account comprising the corresponding card or cards, primary household profile, and/or individual household member profiles, may be used in connection with the market research processors discussed above, to provide a comprehensive system of processing purchasing attitudes and behavior.

Beyond the consumer marketing information captured by the system regarding each profile associated with a household, the system is also adapted to monitor which household member to recruit for involvement in follow-up consumer marketing research regarding the products that a household member may have purchased.

From a consumer marketing research standpoint, the present invention makes it easy to identify consumers using the system of the present invention who have purchased certain items and, as a result, also qualify for participation in consumer marketing research. Consumers who are involved in research panels and programs can be contacted to participate in consumer marketing research studies. As a reward for participation, the consumers may receive a monetary incentive that may be loaded on to their card. These funds can be accessed via any of the means described herein for accessing card data.

As an added bonus to consumers using the system, they can use the system to keep track of every item that they purchase for the home that contains an EPC. Additionally, each product purchased with an EPC will be monitored. Consumers will have access to a website that will provide them with a breakdown of every item they have purchased by category. These consumers could also access a section of the website that will tell them the freshness of specific items that they have purchased for the home. They can get this information because the EPC on each product is able to provide identifying information for each individual unit purchased. Information such as the date code for the product (date of production), expiration date, nutrition facts, price paid, and any other information that the manufacturer wishes to share with purchasers including advertisements and promotional information, can be provided.

Various features of the system of the present invention would be valuable to product manufacturers and other marketers. Thus, the valuable information captured by the system could be sold to product manufacturers and other marketers for the purpose of targeting advertising, or to obtain a picture of the marketplace.

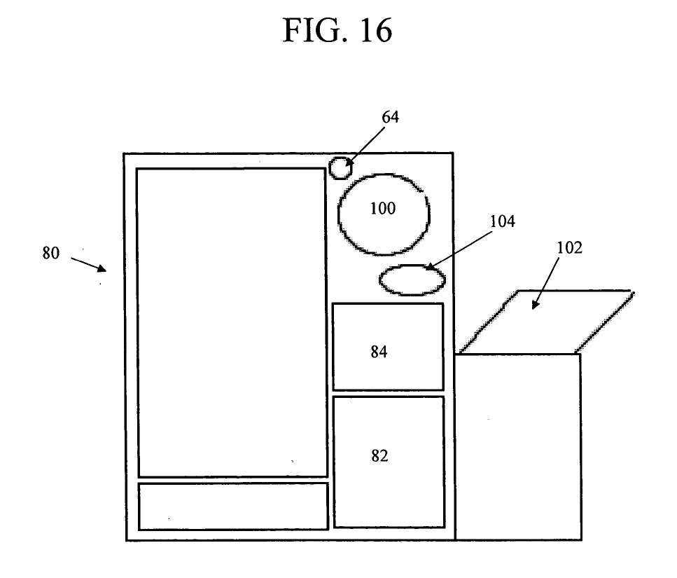

The present system may also incorporate vending machines 80 designed to communicate with the cards, as shown in FIG. 16. A vending machine 80 is provided having a vending card reader 82 capable of accessing the information on the cards 12 when a card is in proximity to the vending card reader 82. The vending card reader 82 may be in communication with the central computer 36, or may comprise a database or computer processor containing information regarding the card 12, and the consumer's profile associated with the card 12. The database or computer processor may also contain product code 24 information. The vending machine 80 contains products or other items offered for sale. The vending machine may further comprise a video monitor 100, a printer 102, an audio speaker 104, and HSS emitter 64, or combinations of each of those. A card kiosk 44 may also be installed in the vending machine 80, including a video monitor 100, a printer 102 and a speaker 104, or HSS emitter 64 for audio capabilities. The vending machine 80 can also be equipped with a biometric scanner 84 having, for example, fingerprint recognition and/or retinal scan capabilities.

In order for a consumer to use a vending machine 80 of the present invention, a consumer with a card 12 simply waves the card in front of the vending machine's card reader 56. The vending machine 80 accesses the information relating to the card 12 and the relevant profile 42. The vending machine 80, via a video monitor 100, printer 102, speaker 104, or HSS emitter 64, is able to provide the consumer with special offers that they qualify for in using the vending machine. For example, if the system has profiled the consumer as a recognized Brand X Cola drinker, the consumer may be offered a Brand Y Cola for free or at a discounted price. Consumers could pay at the vending machine using the card, where the card is tied to credit or debit card information stored by the central computer.

Helpful consumer information could be provided to consumers at the vending machine. For example, the database is adapted to store nutritional information relating to products scanned by the system. Consumers are be able to access the nutritional information regarding items in the vending machine the consumer is interested in purchasing, as well as any other information.

Additionally, the vending machines are designed to keep track of internal inventory via a computer processor or by communicating with the central computer. When items are running low or are held near or beyond the product expiration dates, the vending machine sends a signal to the central via a computer network to advise the supplier of the vending machine the items that need to be restocked.

All consumer marketing research information that is captured by the system of the present invention may be incorporated into a report for reporting to a client. The report may include cross-tabulations and a comprehensive written analysis in text and graphic format. The report is provided to clients who then utilize the information in order to make strategic decisions which will be geared toward, for example, improving the performance of the product in the marketplace or discontinuing a product that is proven not to have the potential to reach the company's performance goals. Typically, research findings can be used to enhance a product itself, the packaging, the marketing, advertising and promotion for a client's product.

Consumer Marketing Research Methodology Examples

Consumer marketing research may generally be conducted by identifying a product to be the focus of the consumer marketing research, developing an appropriate consumer marketing research program, contacting a consumer for participation in the consumer marketing research program, and conducting the consumer marketing research. Results of any consumer marketing research program may be reported to clients. Following is an example of research methodology that may be implemented utilizing the system of the present invention:

In order to gather reactions to new products shortly after launch, the system of the present invention will identify qualified consumers (purchasers of the new product being monitored) for participation in consumer marketing research. Qualified consumers can be invited to participate in the research program in a number of different ways as follows:

by purchasing a new product and discovering a card in or affixed to the product package when they go to use it; or,

if the consumer has already received a card that they have been using in accordance with the system of the present invention to have their purchases monitored in order to receive special offers, shopping lists, etc., the consumer could then be invited to participate in the survey via telephone, direct mail, internet communication, or other acceptable means.

Using this approach, it can be determined with certainty that a consumer purchased a particular product that is the selected target of follow-up research, as the only way the consumer could be invited to participate in the study is: (a) if they bought one of the products that contained the card/incentive offer; or, (b) if they were already participating in a purchaser panel according to the system of the present invention, and on one of the consumer's recent shopping trips, happened to purchase the appropriate item that triggered an invitation for them to participate in our consumer marketing research study.

In addition, the system of the present invention provides an ideal means for building a purchaser panel, in the event that the manufacturer wants to conduct future research with these consumers.

Once consumers participate in an consumer marketing research program according to the system of the present invention and answer all of the appropriate survey questions, they may receive a reward such as, by way of example, cash or coupons loaded onto their card, etc.

Using the example of the launch of a new food product, the types of information typically gathered in a marketing research program may include:

Consumer name, address, telephone number and e-mail address;

Source of product awareness;

Type of store where purchased;

Number of packages purchased;

Reason for purchase;

Whether or not a category purchase was planned, or if this was an impulse purchase;

Whether this product was purchased in addition to or in the place of another product, and if so, what was added or replaced;

When the product was consumed (breakfast, mid-morning snack, lunch, mid-afternoon snack, dinner, evening snack);

Where the product was consumed (car, bus, train, office, home, sport event, etc.),

Whether it was consumed by one person or shared;

Whether one serving is just right, too much or too little for an “on the go” snack;

Ratings on specific product attributes (taste, size, texture, level of sweetness, etc.);

Ratings on specific package attributes (ease of opening, ability to seal in freshness, etc.);

Initial overall satisfaction;

Future purchase intentions;

Demographics; and,

Psychographics.

The survey participants may also be recruited for participation in subsequent research such as direct-mail, telephone or online (web-based) follow-up interviews. The survey participants may also be recruited for participation in subsequent research such as direct-mail, telephone or online (web-based) follow-up interviews. The participants could also be recruited to visit a central location where they will participate in either qualitative (focus groups or in-depth interviews) or quantitative research.

Typically, clients will conduct more in-depth interviews after allowing a specific amount of time for product usage. If desired, each profile maintained by the system can be aged for a specific length of time to allow each consumer the same time frame between purchase of a particular product and re-contact. These interviews can be used to understand actual repurchase behavior, other category purchases made in the elapsed time frame, and more detailed opinions on product diagnostic attributes.

In-depth interviews can include some or any of the following: Focus Groups; One-on-one interviews; Product tests (in-home, or at central location); or, New product concept testing.

Consumer Marketing Research Programs

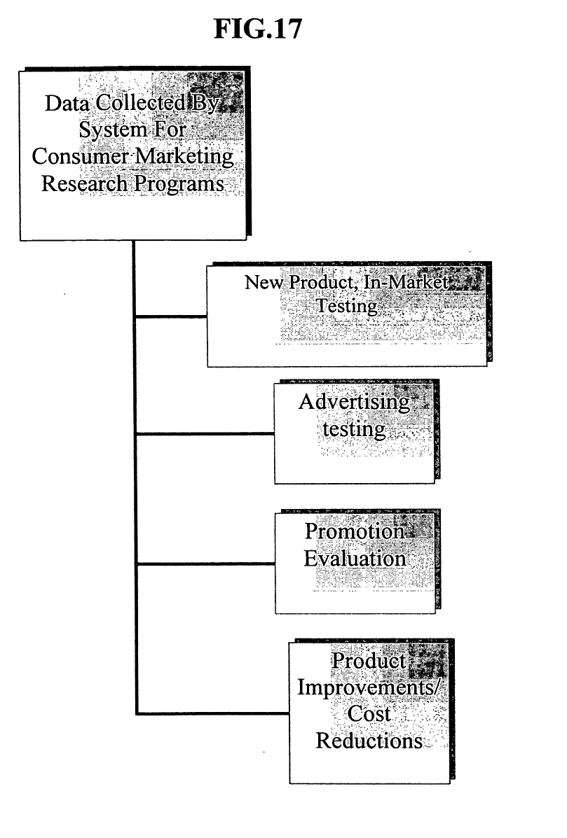

It is appreciated that, according to the system of the present invention, any program directed toward consumer marketing research, whether attitudinal and/or behavioral research or another type of research, could employ the inventions disclosed herein. Illustrative examples of such programs are shown schematically in FIG. 17. The results of any consumer marketing research may be reported to clients such as manufacturers through a user interface provided on the client's personal computer. The following consumer marketing research programs are provided as examples utilizing the data gathered by the system of the present invention consumer marketing research:

New Product, In-Market Testing:

The system of the present invention allows completion of entire quantitative and/or qualitative consumer marketing research programs soon after a product is launched, such as within the first quarter of a new product launch. This provides “real time” marketing intelligence, which in turn identifies potential problems, allows marketing strategy adjustment in the early phases of a marketing campaign, and potentially saves clients millions of dollars. While most new product tracking programs take eight to ten months to provide an initial read on purchasers' attitudes and behaviors, the system of the present invention is designed to provide ongoing and dynamic feedback immediately following a product's launch. As a result, clients can obtain relatively immediate feedback regarding how purchasers think, make purchase decisions, and use the new products through a broad range of data points. Such data points include, but are not limited to:

satisfaction with the product purchased;

ratings on specific product attributes;

reasons for choosing the product purchased;

demographic and psychographic profiles of customers who became loyal purchasers; and,

demographic and psychographic profiles of customers who did not choose to purchase.

Conducting an consumer marketing research program for capturing this data will assist clients such as manufacturers in understanding product strengths, and that understanding can be used to enhance marketing campaigns. If an early understanding is obtained regarding who is purchasing the product and where/when/why/how the product is purchased and used, such marketing intelligence will foster a competitive advantage over other category products. In addition, any product weaknesses can be identified while the product is still in its infancy, so that the manufacturer will have an opportunity to make any adjustments to the product or the marketing campaign necessary to increase the product's likelihood of success in the marketplace.

The system of the present invention enables clients to cost-effectively identify and capture attitudinal and behavioral information from actual purchasers of products launched globally, nationally, regionally, in test markets, learning markets, or just a couple of stores. This includes any type of launch such as new products, restaged products, reformulated products, new packaging, line extensions, etc.

Advertising Testing:

The system of the present invention enables clients to conduct advertising testing among a random sample of consumers who shop at various retail stores in certain geographical markets, or even on a national level.

Consumers carrying one on the cards of the system of the present invention and shopping at stores throughout the country that are equipped with the appropriate equipment for displaying (visually) and/or playing (via audio) advertisements, may be exposed to advertisements for specific products carried in the store. By way of example and not by way of limitation, one of three different advertisements may be utilized to try and entice the consumer to purchase the product featured in the ad. The system of the present invention will enable clients to determine which advertisement was most effective in enticing a consumer to purchase a product featured in the advertisement. The system is designed to provide information to clients based upon behavioral data (sales of the product featured in the advertisement), which advertisement resulted in the greatest number of sales, and the profile (demographic, psychographic, purchase history, etc.) of consumers who reacted most positively to the advertisement. Thus, the information gathered by the system allows clients to determine the best ways to reach similar consumers with the winning advertisement (the advertisement having the most positive feedback as measured through purchasing behavior) in order to increase sales for the product featured in the ad, or to design future products or services.

Clients may further choose to interview consumers who were exposed to one of the advertisements while shopping, to capture attitudinal reactions toward what the consumers were exposed to in the store. These consumers may be invited to participate in this consumer marketing research either at the store level, or via telephone, internet email, direct-mail, in-person, etc. Those consumers who agree to take part in a consumer marketing survey such as an attitudinal survey may receive a reward at the conclusion of the survey. This reward may be downloaded onto the participant's card.

Promotion Evaluation:

Different promotions may be tested in a similar fashion to the advertising evaluation described above. Special discount offers can be tested at various levels in order to determine which are most effective in enticing consumers to purchase the product being promoted.

Product Improvements/Cost Reductions:

The system of the present invention can be utilized to monitor consumer reactions to changes in product formulations, ingredient changes, product package changes, and materials changes. It is common practice for major product manufacturers to look for ways to improve production efficiencies by changing product formulations, packaging or materials used in the production of their products. The system of the present invention will enable manufacturers to easily test such changes in the manufacturing of their products in-market with current purchasers of their products. This marketing research program will enable manufacturers to quantitatively measure levels of product satisfaction, as well as to assess product performance on key indicators and determine repurchase interest—all before the new formulation ships to stores nationally.

Following is an example of how the system of the present invention functions in connection with a product reformulation for cost saving purposes:

When a major manufacturer reformulates a product to enable the manufacturer to save costs during production, typically there is interest in ensuring that current purchasers of the product be unable to determine that there has been a formulation change. A program according to the system of the present invention may be designed such that the test product (new formulation) would be produced and placed in the same packaging as the control product (current formulation). According to the system of the present invention, each formulation will have either a unique chip or invitation to participate in a survey (the invitation will contain the chip). A coding system is established to identify who purchased the test product and who purchased the control product. Consumers may then be invited to give their reactions to the product that was purchased without being told that the product they purchased may or may not have been modified. Both groups of purchasers would then be contacted once again for follow-up attitudinal research after having an equal amount of time to use the product and determine how well they like it.

One of the goals of such a program is to determine whether a new formulation is performing at parity or better than an original formulation prior to launching the new formulation nationally. The results of a follow-up survey allow a product manufacturer to determine which formulation performed best, and whether the manufacturer could move ahead with the new formulation without the risk of alienating current purchasers, which would likely result in loss of market share.

The programs may be offered to major product manufacturers interested in conducting marketing research or receiving marketing research information that has already been gathered regarding purchasers of specific products.

Utilization Of Results Of Consumer Marketing Research

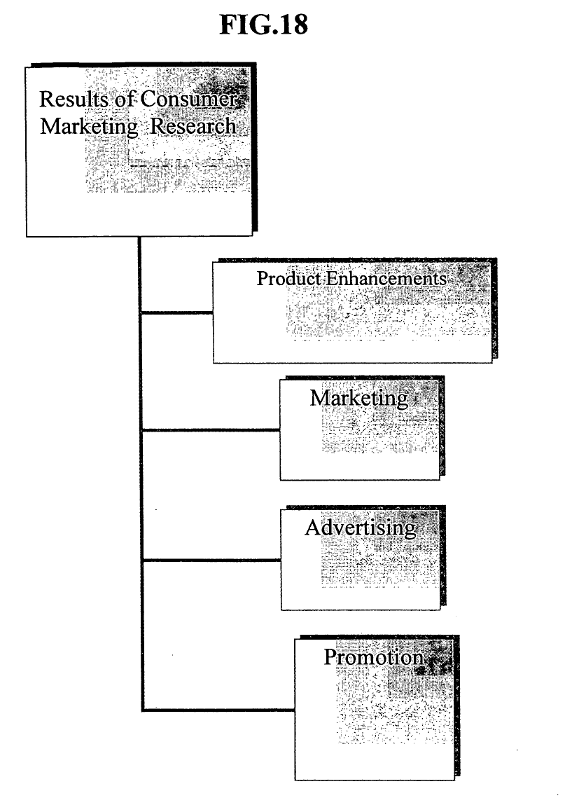

Clients will be able to utilize the findings (consumer marketing research findings) compiled by the system, as shown schematically in FIG. 18, in order to enhance their products and/or marketing, advertising and promotional programs for their products, as follows:

Product Enhancements: Clients may utilize the system of the present invention in order to identify actual purchasers of a new product immediately following launch. Based upon research findings that are gathered among actual purchasers after extended usage, the clients may decide to modify the product's packaging, pricing, formulation, production facilities, etc., in order to produce the best product they can. This should, in turn, maximize profitability of the product for the company.

Marketing: Clients may utilize the system in order to determine, based upon information gathered from actual purchasers, the most appropriate new product to introduce in order to appeal to an existing client base. Clients can utilize the research programs of the present invention to determine an appropriate price range for a new product. The research programs of the present invention can also be used to determine which stores and/or types of stores would be best for offering a new product in order to maximize the likelihood of reaching the appropriate target audience for the new product. The research programs of the present invention can also be utilized to assist clients in determining what types of special offers or in-store displays to utilize during the product's life-cycle in order to stimulate the sales among their target audience.

Advertising: The system of the present invention will enable clients to test advertising among target audiences in realistic in-store environments without having to notify consumers that a test is being conducted. The cards of the present system and the data captured through use of the cards will enable clients to determine which advertisement consumers were exposed to, and which advertisements resulted in the most sales of specific products featured in the ads. Furthermore, the present system can be utilized to more cost-effectively identify qualified purchasers of specific products in order to conduct consumer marketing advertising research among actual purchasers. This research will enable manufacturers to determine the appropriate content to include in their ads in order to appeal best to the product's target audience. The research programs of the present invention will also enable clients to determine where and when clients should run their advertisements in order to produce the best results for the product being advertised.

Promotion: The system of the present invention will enable clients to monitor consumer behavior with regard to products that are purchased. This will make it possible to cost-effectively determine which promotions are most effective in stimulating sales of the products being promoted. Furthermore, the system of the present invention will enable clients to cost-effectively recruit consumers who responded to certain promotions and conduct consumer marketing research with these consumers to determine the profile of these consumers (demographic and psychographic) and what it was about certain promotions that appealed to consumers most. The research programs of the present invention will enable clients to create more effective targeted promotions that can then be utilized in order to increase the sales of the products being promoted.

It is understood that the present invention is not limited to the particular embodiments shown and described herein, but that various changes and modifications may be made without departing from the scope and spirit of the invention.

What is claimed is:

1. A consumer marketing research method, comprising:
a. making available to at least one consumer a card comprising a microchip for storing information;
b. activating the card via a triggering event;
c. creating a consumer profile corresponding to the card in a central computer;
d. enabling the at least one consumer to use the activated card when purchasing items;
e. providing a card processor for performing at least one of accessing any information stored on the microchip, identifying any items purchased by the consumer, and recording information about the consumer's purchases;
f. transferring information processed by the card processor to the profile; and,
g. performing consumer marketing research using the consumer profile.

2. The method of claim 1, wherein the card is made available by associating the card with a product at a point of sale.

3. The method of claim 1, wherein the card is made available by distribution of a sample product.

4. The method of claim 1, wherein the card is made available using a direct mailing.

5. The method of claim 1, wherein the card is made available to a consumer in connection with a purchasing incentive.

6. The method of claim 5, wherein the purchasing incentive is a preselected amount of cash.

7. The method of claim 5, wherein the purchasing incentive is a coupon.

8. The method of claim 5, wherein the purchasing incentive is a free product.

9. The method of claim 1, wherein the triggering event is participation in a consumer survey.

10. The method of claim 1, wherein the triggering event is participation in market research program.

11. The method of claim 1, wherein the triggering event is participation in a focus group.

12. The method of claim 1, wherein the triggering event is processing the card via the card processor.

13. The method of claim 1, wherein the triggering event is utilizing a card kiosk to activate the card.

14. The method of claim 1, wherein the triggering event is using the card during checkout at a retail store after selecting items for purchase.

15. The method of claim 1, further comprising the step of transferring information in the consumer profile from the central computer to the card processor.

16. The method of claim 15, further comprising the step of writing information from the card processor to the microchip on the card.

17. The method of claim 1, further comprising the step of storing information stored on the microchip on the card in a card processor memory.

18. The method of claim 17, further comprising the step of transferring information stored in the card processor memory to the central computer.

19. The method of claim 1, further comprising the step of storing information relating to items purchased by a consumer during checkout in a card processor memory.

20. The method of claim 1, further comprising the step of providing an internet website for allowing the at least one consumer to access information associated with the profile.

21. The method of claim 20, further comprising the step of providing an internet website for allowing the at least one consumer to manage the profile.

22. The method of claim 1, further comprising the step of targeting advertisements to the at least one consumer based upon information compiled in the consumer profile.

23. The method of claim 1, further comprising the step of registering the at least one consumer to participate in a consumer marketing research program.

24. The method of claim 1, further comprising the step of making available to the at least one consumer a card kiosk in communication with the central computer.

25. The method of claim 24, wherein the card kiosk enables the at least one consumer to access the information of the consumer profile using the card kiosk.

26. The method of claim 25, wherein the card kiosk enables the at least one consumer to manage the consumer profile.

27. The method of claim 24, wherein the card kiosk enables the at least one consumer to receive incentives downloaded to the microchip on the card using the card kiosk.

28. The method of claim 24, further comprising the step of enabling the at least one consumer to use the card kiosk to access the information relating to the profile corresponding to the card.

29. The method of claim 24, further comprising the step of enabling the at least one consumer to use the card kiosk to print out product information.

30. The method of claim 24, further comprising the step of enabling the at least one consumer to use the card kiosk to print out coupons.

31. The method of claim 24, further comprising the step of enabling the at least one consumer to use the card kiosk to print out shopping lists.

32. The method of claim 24, further comprising the step of enabling the at least one consumer to use the card kiosk to print out lists of items suggested for purchase based upon information in the consumer profile.

33. The method of claim 24, further comprising the step of enabling the at least one consumer to use the card kiosk to input an amount of cash value to the microchip on the card for later redemption.

34. The method of claim 1, further comprising the step of utilizing the results of the consumer marketing research for product enhancement.

35. The method of claim 1, further comprising the step of utilizing the results of the consumer marketing research for marketing.

36. The method of claim 1, further comprising the step of utilizing the results of the consumer marketing research for advertising enhancement.

37. The method of claim 1, further comprising the step of utilizing the results of the consumer marketing research for determining whether promotions are effective.

38. The method of claim 1, further comprising the step of reporting the results of the consumer marketing research to a client.

39. The method of claim 1, wherein the step of the performing consumer marketing research further comprises:
a. identifying a product to be the focus of consumer marketing research;
b. developing a consumer marketing research program;
c. contacting the at least one consumer for participation in the consumer marketing research program; and,
d. conducting the consumer marketing research.

40. The method of claim 39, further comprising the step of reporting the results of the consumer marketing research to a client.

41. The method of claim 1, wherein the consumer marketing research comprises attitudinal research.

42. The method of claim 1, wherein the consumer marketing research comprises behavioral research.

43. The method of claim 39, wherein the consumer marketing research comprises attitudinal research.

44. The method of claim 39, wherein the consumer marketing research comprises behavioral research.

45. A consumer marketing research method, comprising:
a. making available to at least one consumer a card comprising a microchip for storing information;
b. activating the card via a triggering event;
c. creating a consumer profile corresponding to the card in a central computer;
d. enabling the at least one consumer to use the activated card when purchasing items;
e. providing a card processor for performing at least one of accessing any information stored on the microchip, identifying any items purchased by the consumer, and recording information about the consumer's purchases;
f. transferring information processed by the card processor to the profile;
g. performing consumer marketing research using the consumer profile; and,
h. providing an incentive to the consumer for purchasing a selected product based upon the information in the profile.

46. The method of claim 45, wherein the incentive is accessed by the consumer by processing the card via a card kiosk.

47. The method of claim 45, wherein the incentive is accessed by using the card when purchasing items at a retail store.

48. The method of claim 45, wherein the incentive is accessed by using an internet website in communication with the central computer.

49. The method of claim 45, further comprising the step of utilizing the results of the consumer marketing research for product enhancement.

50. The method of claim 45, further comprising the step of utilizing the results of the consumer marketing research for marketing.

51. The method of claim 45, further comprising the step of utilizing the results of the consumer marketing research for advertising testing.

52. The method of claim 45, further comprising the step of utilizing the results of the consumer marketing research for determining whether promotions are effective.

53. The method of claim 45, further comprising the step of reporting the results of the consumer marketing research to a client.

54. The method of claim 45, wherein the step of the performing consumer marketing research further comprises:
a. identifying a product to be the focus of consumer marketing research;
b. developing a consumer marketing research program;
c. contacting the at least one consumer for participation in the consumer marketing research program; and,
d. conducting the consumer marketing research program.

55. The method of claim 54, further comprising the step of reporting the results of the consumer marketing research to a client.

56. The method of claim 45, wherein the consumer marketing research comprises attitudinal research.

57. The method of claim 45, wherein the consumer marketing research comprises behavioral research.

58. The method of claim 54, wherein the consumer marketing research comprises attitudinal research.

59. The method of claim 54, wherein the consumer marketing research comprises behavioral research.

60. A consumer marketing research method, comprising:
a. making available to at least one consumer a card comprising a microchip for storing information;
b. activating the card via a triggering event;
c. creating a consumer profile corresponding to the card in a central computer;
d. enabling the at least one consumer to use the activated card when purchasing items;
e. providing a card processor for performing at least one of accessing any information stored on the microchip, identifying any items purchased by the consumer, and recording information about the consumer's purchases;
f. transferring information processed by the card processor to the profile;
g. transferring information processed by the card processor to the microchip on the card; and,
h. providing at least one card reader at a selected location in a retail store for accessing information stored on the microchip.

61. The method of claim 60, wherein the card reader is in communication with the central computer.

62. The method of claim 60, further comprising the step of delivering at least one targeted advertisement to the at least one consumer while the consumer is shopping in a retail store.

63. The method of claim 62, wherein the advertisement is delivered to the at least one consumer via hypersonic sound.

64. The method of claim 62, wherein the advertisement is delivered to the at least one consumer via a video monitor.

65. The method of claim 62, wherein the advertisement is delivered to the at least one consumer via a printer.

66. The method of claim 62, further comprising the step of performing consumer marketing research using information in the consumer profile.

67. The method of claim 66, wherein the consumer marketing research comprises attitudinal research.

68. The method of claim 66, wherein the consumer marketing research comprises behavioral research.

69. A consumer marketing research method, comprising:
a. making available to at least one consumer a card comprising a microchip for storing information;
b. activating the card via a triggering event;
c. creating a consumer profile corresponding to the card in a central computer;
d. enabling the at least one consumer to use the activated card when purchasing items;
e. providing a card processor for performing at least one of accessing any information stored on the microchip, identifying any items purchased by the consumer, and recording information about the consumer's purchases;
f. transferring information processed by the card processor to the profile;
g. transferring information from the consumer profile to the microchip on the card;
h. accessing the information stored on the microchip on the card using a shopping cart processor in communication with the central computer; and,
i. performing consumer marketing research using the consumer profile.

70. The method of claim 69, wherein the shopping cart processor is adapted to write information accessed from the central computer to the microchip on the card.

71. The method of claim 69, wherein the shopping cart processor is adapted to access product code information for items placed in or near the shopping cart processor.

72. The method of claim 69, wherein the shopping cart processor is adapted to convey information relating to items placed in the cart to the at least one consumer.

73. The method of claim 69, wherein the shopping cart processor is adapted to communicate with the card processor.

74. The method of claim 69, wherein the consumer marketing research comprises attitudinal research.

75. The method of claim 69, wherein the consumer marketing research comprises behavioral research.

76. A consumer marketing research method, comprising:
a. making available to at least one consumer a card comprising a microchip for storing information;
b. activating the card via a triggering event;
c. creating a consumer profile corresponding to the card in a central computer;
d. enabling the at least one consumer to use the activated card when purchasing items;
e. providing a card processor for performing at least one of accessing any information stored on the microchip, identifying any items purchased by the consumer, and recording information about the consumer's purchases;
f. transferring information processed by the card processor to the profile;
g. transferring information from the consumer profile to the microchip on the card;
h. delivering at least one advertisement for at least one product to the at least one consumer based upon information accessed from the microchip on the card; and,
i. tracking the consumer's response to the advertisement based upon the consumer's purchasing habits when using the card for shopping.

77. The method of claim 76, wherein the advertisement is delivered to the at least one consumer via hypersonic sound.

78. The method of claim 76, wherein the advertisement is delivered to the at least one consumer via a video monitor.

79. The method of claim 76, wherein the advertisement is delivered to the at least one consumer in printed form.

80. The method of claim 76, further comprising the step of performing consumer marketing research to study the consumer's purchasing habits in connection with the advertisement.

81. The method of claim 80, wherein the consumer marketing research comprises attitudinal research.

82. The method of claim 80, wherein the consumer marketing research comprises behavioral research.

83. A system for performing consumer marketing research, comprising:
a. a means for delivering a card comprising a microchip including a memory for storing information regarding purchasing habits of at least one consumer;
b. a central computer for storing information accessed from the microchip on the card;
c. a card processor adapted to access information stored on the microchip on the card, said card processor being in communication with the central computer and adapted to transfer information to and receive information from the central computer;
d. a consumer profile developed in the central computer comprising a compilation of information regarding a consumer's purchasing habits; and,
e. a consumer marketing research program developed to utilize the information compiled in the consumer profile.

84. The system of claim 83, wherein the means for delivering a card comprises a product having a card associated therewith at a point of sale.

85. The system of claim 83, wherein the means for delivering a card comprises a product sample having a card associated therewith.

86. The system of claim 83, wherein the card processor is adapted to write information to the microchip for storage on the card.

87. The system of claim 83, wherein the card processor is in communication with a computerized scanner of a cash register at a retail store and receives from said computerized scanner information regarding product purchases made by a consumer using the card.

88. The system of claim 83, further comprising a card kiosk adapted to access the information stored on the microchip on the card.

89. The system of claim 88, wherein the card kiosk further comprises a printer.

90. The system of claim 88, wherein the card kiosk further comprises a video display.

91. The system of claim 88, wherein the card kiosk further comprises a card reader for accessing information stored on a card.

92. The system of claim 88, wherein the card kiosk is in communication with the central computer, and is adapted to access the information in the consumer profile.

93. The system of claim 83, further comprising an internet website in communication with the central computer accessible by a consumer for managing the consumer profile.

94. The redemption and market research system of claim 93, further comprising a card kiosk in communication with the central computer and the internet website, said card kiosk comprising means for accessing information entered into the internet website.

95. The system of claim 88, further comprising a means for delivering targeted advertisements to the at least one consumer.

96. The system of claim 88, further comprising a means for delivering coupons to the at least one consumer.

97. The system of claim 83, further comprising at least one card reader adapted to access information on the microchip of a card in proximity with the card reader, the card reader located in a retail store and adapted to be in communication with at least one of the card processor and central computer.

98. The system of claim 97, further comprising a means for delivering at least one advertisement to the consumer.

99. The system of claim 83, further comprising a market research processor placed in a consumer's home in communication with the central computer.

100. The system of claim 83, further comprising means for positively identifying a card user.

101. The system of claim 83, further comprising a vending machine comprising a vending card reader adapted to access information stored on the microchip of a card.

102. The system of claim 83, wherein the consumer marketing research program comprises new product, in-market testing.

103. The system of claim 83, wherein the consumer marketing research program comprises advertising testing.

104. The system of claim 83, wherein the consumer marketing research program comprises promotional evaluation.

105. The system of claim 83, wherein the consumer marketing research program comprises product improvement analysis.

106. The system of claim 83, wherein the consumer marketing research program comprises production improvement analysis.

107. The system of claim 83, wherein the consumer marketing research program comprises attitudinal research.

108. The system of claim 83, wherein the consumer marketing research program comprises behavioral research.

109. The system of claim 83, further comprising: a product package comprising a microchip for storing information about the product; and, a portable electronic device adapted to access at least one of the microchip on the product package and the central computer.

110. The system of claim 109, wherein the portable electronic device is adapted to access information stored on the microchip of the card.

111. The system of claim 109, further comprising a terminal in communication with the central memory and portable electronic device.

112. The system of claim 111, wherein the terminal further comprises a means for providing printed materials.
